(19) United States
(12) Patent Application Publication
(10) Pub. No.: US 2010/0124230 A1
(43) Pub. Date: May 20, 2010

(54) TERMINAL APPARATUS AND PROGRAM

(75) Inventors: Hironori Sakakihara, Kawasaki (JP); Eiji Hasegawa, Kawasaki (JP); Fumio Honda, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/620,563

(22) Filed: Nov. 17, 2009

(30) Foreign Application Priority Data
Nov. 19, 2008 (JP) 2008-296093
Mar. 17, 2009 (JP) 2009-064991

(51) Int. Cl. H04L 12/56

(52) U.S. Cl. 370/400

(57) ABSTRACT

An apparatus transmits reservation information including a contents-ID identifying the contents and a terminal-ID identifying the apparatus that transmits the reservation information to the apparatus determined by the contents-ID, receives the reservation information transmitted from the apparatus that accepts the reservation operation and updates a reservation terminal list that associates the contents-ID and the terminal-ID, verifies whether the acquired contents have defects, transmits a search-request having the contents-ID identifying the contents judged that have defects to the apparatus determined by the contents-ID, receives the search-request transmitted from the apparatus judged that have defects, retrieves the terminal-ID registered in association with the contents-ID of the search-request from the reservation terminal list, transmits a search-result having the acquired terminal-ID, receives a search-result from the apparatus to which the search-request is transmitted, and acquires recovery data of the contents that have defects from the apparatus identified by the terminal-ID of the search-result.

### CROSS-REFERENCE TO RELATED APPLICATIONS

This application claims the benefit of priority from Japanese Patent Application No. 2008-296093 filed on Nov. 19, 2008, and Japanese Patent Application No. 2009-64991 filed on Mar. 17, 2009, which is herein incorporated by reference in its entirety.

### BACKGROUND

1. Field

Various embodiments of the present invention relate to a terminal apparatus to transmit and receive information such as motion pictures, music, images, and programs (hereinafter, denoted as “contents”).

2. Description of the Related Art

In contrast to a client-server type (C-S type), a P2P system capable of relaying messages between information processing apparatuses (nodes) without going through a specific server apparatus is proposed.

The P2P system has an advantage in that there is no need to install a specific server that manages information in a unified way like the C-S type because when a search request of information is received, a search processing according to the search request is not only performed in the local node, but also the search request is transferred to other nodes.

Japanese Patent Application Laid-Open No. 2008-020938 describes an information sharing system including a plurality of node apparatuses mutually communicable via a network and a storage instruction apparatus that causes the plurality of node apparatuses to store a plurality of pieces of shared information shared among the plurality of node apparatuses.

The storage instruction apparatus in the information sharing system includes a shared information acquisition unit that acquires shared information that is input into the information sharing system and made sharable by the plurality of node apparatuses, an advance reservation information acquisition unit that acquires advance reservation information containing at least one piece of node apparatus identification information to identify the node apparatus that has made a purchase reservation of the acquired shared information, and a storage instruction unit that sends out the acquired shared information and storage instruction information that instructs storage of the shared information to the node apparatus identified based on node apparatus identification information contained in the advance reservation information.

Accordingly, the node apparatus that makes a purchase reservation of newly input shared information is instructed to store the contents in such a way that the contents are maintained sharably with other node apparatuses and therefore, after shared information is made public, there is no need for the node apparatus that makes a purchase reservation to receive delivery from other node apparatuses by performing a search of the shared information.

As a result, an increase in load on a specific node apparatus is assumed to be preventable after shared information is made public.

### SUMMARY

According to an aspect of the embodiment described bellow, a terminal apparatus connectable as a node apparatus to an information sharing system having a plurality of node apparatuses mutually communicable via a network.

The terminal apparatus accepts an operation to reserve reception of contents, transmits reservation information including a contents ID to identify the contents whose reservation operation is accepted and terminal information to identify the terminal apparatus that accepts the reservation operation to the terminal apparatus determined based on the contents ID, receives the reservation information transmitted from the terminal apparatus that accepts the reservation operation of delivery of the contents and that updates a reservation terminal list that associates the contents ID to identify the contents and the terminal information to identify the terminal apparatus reserved for delivery of the contents based on the received reservation information, verifies whether or not the acquired contents have defects when the contents whose reservation operation is accepted are acquired, transmits a search request having the contents ID to identify the contents judged to have defects to the terminal apparatus determined based on the contents ID to acquire a search result from the terminal apparatus to which the search request is transmitted, receives the search request transmitted from the terminal apparatus judged to have defects in the delivered contents, acquires the terminal information registered correspondingly to the contents ID included in the search request from the reservation terminal list, transmits the acquired terminal information as a search result, and acquires recovery data of the contents judged to have defects from the terminal apparatus identified by the terminal information included in the search result to perform recovery of the contents using the acquired recovery data.

### BRIEF DESCRIPTION OF THE DRAWINGS

FIG. 1 illustrates a configuration of a system;

FIG. 2 illustrates a hardware configuration of a terminal apparatus;

FIG. 3 illustrates the hardware configuration of a delivery apparatus;

FIG. 4 illustrates the configuration of a program executed by the terminal apparatus;

FIG. 5 illustrates the flow of processing of a system;

FIG. 6 illustrates the flow of reservation processing in a request unit PG100 performed by the terminal apparatus;

FIG. 7 illustrates the flow of reservation processing in a management unit PG200 performed by the terminal apparatus;

FIG. 8 illustrates the flow of recording processing in the request unit PG100 performed by the terminal apparatus;

FIG. 9 illustrates the flow of owning candidate search processing in the request unit PG100 performed by the terminal apparatus;

FIG. 10 illustrates the flow of owning candidate search processing in the management unit PG200 performed by the terminal apparatus;

FIG. 11 illustrates an example of a terminal list transmitted from a terminal apparatus C;

FIG. 12 illustrates an example of a reservation screen;

FIG. 13 illustrates an example of an Electronic Program Guide information table PG111;

FIG. 14 illustrates an example of reservation information transmitted from a terminal apparatus A;

FIG. 15 illustrates an example of a reservation terminal list held by the terminal apparatus C;

FIG. 16 illustrates the data structure of a terminal list PG110;

FIG. 17 illustrates the data structure of the Electronic Program Guide information table PG111;

FIG. 18 illustrates the data structure of a contents management table PG112;

FIG. 19 illustrates the data structure of a reservation list PG113;

FIG. 20 illustrates the data structure of a verification information DB (PG114);

FIG. 21 illustrates the data structure of a contents DB (PG115);

FIG. 22 illustrates the data structure of an owning candidate DB (PG 116);

FIG. 23 illustrates the data structure of a reservation terminal list PG210;

FIG. 24 illustrates the flow of complementary information transmission processing in the management unit PG200 performed by the terminal apparatus;

FIG. 25 illustrates the configuration of a program executed by the terminal apparatus according to a second embodiment;

FIG. 26 illustrates the flow of recording processing in the request unit PG100 according to the second embodiment;

FIG. 27 illustrates the configuration of a program executed by the terminal apparatus according to a third embodiment;

FIG. 28 illustrates the flow of processing of a system according to the third embodiment;

FIG. 29 conceptually illustrates the flow of reservation information shared in a system according to the third embodiment;

FIG. 30 illustrates the flow of reservation processing in the management unit PG200 performed by the terminal apparatus according to the third embodiment;

FIG. 31 illustrates the flow of owning candidate search processing in the request unit PG100 performed by the terminal apparatus according to the third embodiment;

FIG. 32 illustrates the configuration of the program executed by the terminal apparatus according to a fourth embodiment;

FIG. 33 illustrates the flow of recording processing in the request unit PG100 according to the fourth embodiment;

FIG. 34 illustrates the configuration of the program executed by the terminal apparatus according to a fifth embodiment;

FIG. 35 illustrates the flow of owning candidate search processing in the management unit PG200 performed by the terminal apparatus according to the fifth embodiment;

FIG. 36 illustrates the configuration of the program executed by the terminal apparatus according to a sixth embodiment;

FIG. 37 illustrates the data structure of a connection result list and an example thereof;

FIG. 38 illustrates the data structure of the connection result list and an example (Part 2) thereof; and

FIG. 39 illustrates the flow of processing of the system according to the sixth embodiment.

### DETAILED DESCRIPTION OF THE EMBODIMENTS

A conventional storage-type service is a service in which contents are delivered by using broadcasting or multicast communication and a user of each node may download contents into a recording medium held by each node to use (view) the downloaded contents at any time the user pleases.

In this service, a viewer specifies (reserves) a program to be stored in advance by using Electronic Program Guide (EPG) information.

When the delivery time of the specified program comes, the node starts to receive the specified program, which is accumulated in a recording medium accessible from the node.

The viewer may view the contents accumulated in the recording medium at any time he (she) pleases.

Here, when contents (program data) are delivered, meteorological conditions such as a rainfall and snow may cause a possibility of a loss of a portion of delivered program data at the receiving node in a system that uses radio broadcasting. Further, a network failure or the like may cause a possibility of a loss of a portion of delivered program data not only at the receiving node in a system that uses radio broadcasting but also at the receiving node in a system that uses wire broadcasting.

Thus, a system described below distributes recovery data for recovering contents data having different loss locations at each node, using P2P architecture.

In order to share information among nodes in a P2P system, each node preferably notifies other nodes participating in the P2P system about owned information.

Thus, after contents delivery is completed, a notification of owned contents is issued by respective nodes that have received the contents.

If ordinary consumer devices such as broadcasting receivers set up in each home are participating in a P2P system as nodes, the number of nodes in the P2P system will be enormous compared to that of a conventional P2P system.

If a notification of owned contents is issued by many nodes that have received the contents after the contents delivery is completed, the communication load increases temporarily in a P2P network leading to a communication failure.

After verification processing on delivered contents, a contents search request to search for data to complement defective locations is issued.

Also similarly in this case, if a contents search request is issued by many nodes, the communication load increases temporarily in a P2P network leading to a communication failure.

Embodiments described below propose a method where terminal apparatuses avoid load concentration when data to perform recovery of defective contents is delivered in a P2P system.

According to such terminal apparatuses, load concentration may effectively be avoided when data to perform recovery of defective contents is delivered in a P2P system.

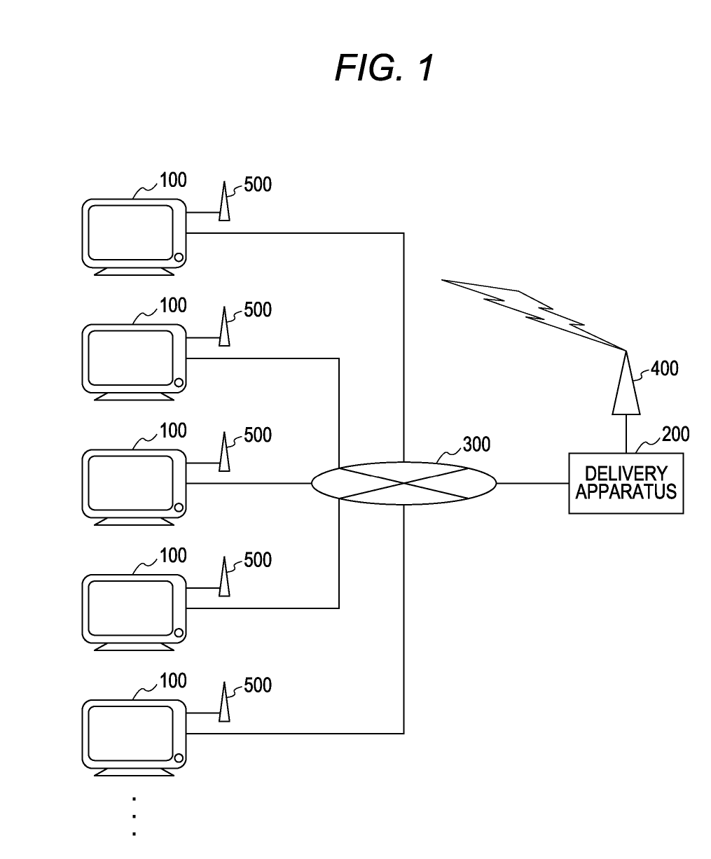

### First Embodiment

[1. System overview] FIG. 1 illustrates an overview of a system according to the present embodiment.

The system illustrated in FIG. 1 includes a plurality of terminal apparatuses 100, a delivery apparatus 200, a communication line 300, a radio transmitter 400, and a radio receiver 500.

The Internet, a local area network (LAN), or a wireless LAN (wireless local area network) may be used as the communication line 300, for example.

The terminal apparatus 100 and the terminal apparatus 100, and the terminal apparatus 100 and the delivery apparatus 200 may perform communication using a protocol such as TCP/IP (Transmission Control Protocol/Internet Protocol) or UDP/IP (User Datagram Protocol/Internet Protocol), or the like via the communication line 300.

The terminal apparatus 100 may receive information transmitted from the delivery apparatus 200 via the radio transmitter 400 and the radio receiver 500.

Also, the terminal apparatus 100 may receive information transmitted from the delivery apparatus 200 via the radio transmitter 400, the radio receiver 500, and a set-top box 600 (not shown).

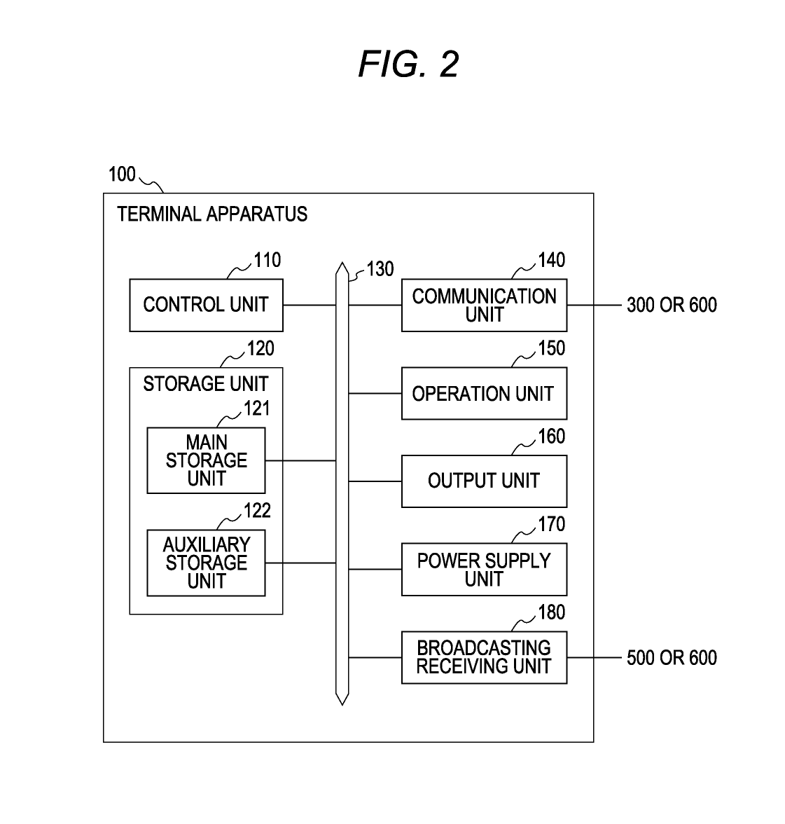

As the terminal apparatus 100, a general-purpose computer, a PDA (Personal Digital Assistant), a mobile phone, and/or a consumer device (for example, a TV set, recording device, refrigerator, and air-conditioner) may be used.

[2. Configuration of the terminal apparatus] [2-1. Hardware configuration of the terminal apparatus] FIG. 2 illustrates the configuration of a terminal apparatus according to the present embodiment.

The terminal apparatus illustrated in FIG. 2 includes a control unit 110, a storage unit 120, a communication unit 140, an operation unit 150, an output unit 160, a power supply unit 170, and a broadcasting receiving unit 180, and these units are communicably connected via a communication line 130.

The control unit 110 is a unit that realizes given functions according to procedures of programs stored in the storage unit 120, and is connected to each unit of hardware of the terminal apparatus via the communication line 130.

As the control unit 110, for example, a CPU (Central Processing Unit), a MPU (Micro Processing Unit), or the like may be used.

The storage unit 120 is a unit that stores both a program and data which the control unit executes and refers to.

For example, the storage unit 120 includes a main storage unit 121 and an auxiliary storage unit 122, and reads, into the main storage unit 121, a program stored in the auxiliary storage unit 122 by processing of the control unit 110 connected via the communication line 130.

The storage unit 120 also transfers data and instruction codes contained in the program read into the main storage unit 121 to the control unit 110.

As the main storage unit 121, for example, a RAM (Random Access Memory) or ROM (Read Only Memory) may be used.

As the auxiliary storage unit 122, for example, an HDD (Hard Disk Drive), flash memory, or SSD (Solid State Disk) may be used.

The communication unit 140 is a unit that transmits and receives a signal to and/or from the terminal apparatus 100 by a wire system or a radio system via the communication line 300.

The operation unit 150 is a unit that receives an operation of the user, and outputs a signal in accordance with the operation of the user to the control unit 110 via the communication line 130.

The operation unit 150, for example, may include input buttons or a touch panel.

The power supply unit 170 is a unit that receives the supply of power necessary for operation of the terminal apparatus 100 and supplies power to each unit via a power supply destination (not shown).

The power supply unit 170 also controls the amount of power supplied to each unit via the power supply destination (not shown) in accordance with instructions from the control unit 110 connected via the communication line 130.

In the present embodiment, the power supply unit 170 may be configured to receive the supply of power from an external power supply or from a primary battery or secondary battery mounted in the terminal apparatus 100.

The broadcasting receiving unit 180 is a unit that receives, for example, digital broadcasting, converts the received broadcast signal into a data format that may be processed by the control unit 110, and supplies the converted data to the control unit 110 via the communication line 130.

The broadcasting receiving unit 180 has a function to separate contents data having dynamic images and sound and Electronic Program Guide information of broadcast programs from a received radio signal of digital broadcasting.

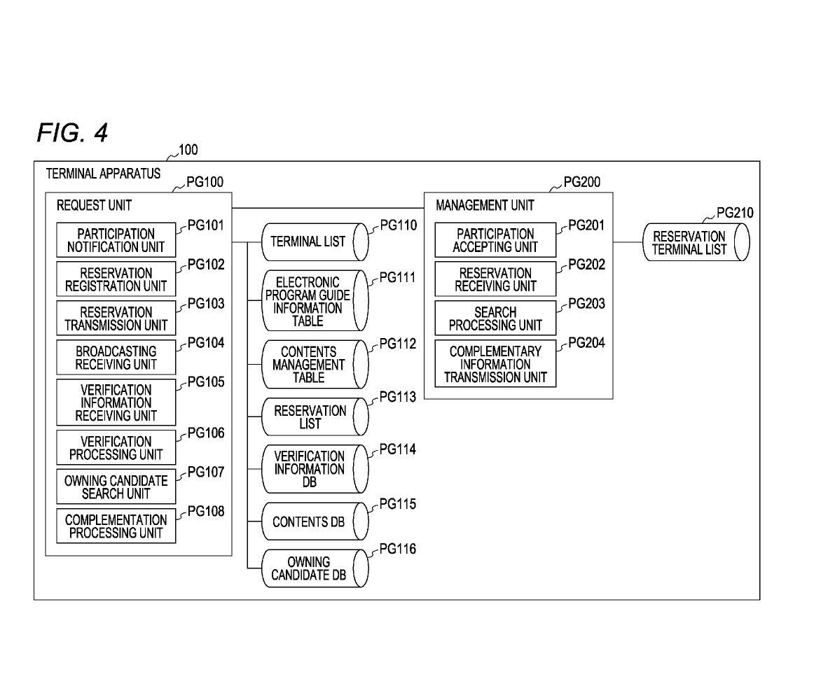

The above functions of the broadcasting receiving unit uses conventional technology and thus, a detailed description thereof is omitted.

[2-2. Configuration of a program in the terminal apparatus] FIG. 4 illustrates components of a program executed in a terminal apparatus according to the present embodiment.

Components of the program illustrated in FIG. 4 include a request unit PG100 and a management unit PG200.

An overview of each component will be provided below.

[2-2-1. Overview of the request unit PG100] As illustrated in FIG. 4, the request unit PG100 includes a participation notification unit PG101, a reservation registration unit PG102, a reservation transmission unit PG103, a broadcasting receiving unit PG104, a verification information receiving unit PG105, a verification processing unit PG106, an owning candidate search unit PG107, and a complementary processing unit PG108.

The control unit 110 operating as a component according to the request unit PG100 may reference a terminal list PG110, an Electronic Program Guide information table PG111, a contents management table PG112, a reservation list PG113, a verification information DB PG114, a contents DB PG115, and the owning candidate DB PG116, and the like.

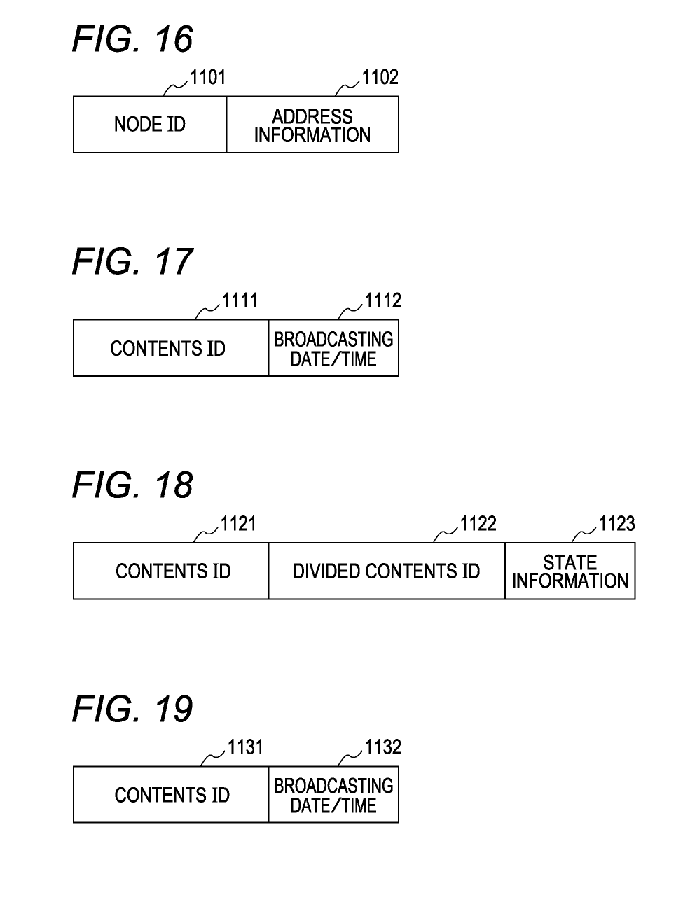

The terminal list PG110 is stored in the storage unit 120 in a format that allows organization of a plurality of records, each of which is terminal information having a node ID 1101 and address information 1102 (see FIG. 16).

The node ID 1101 is information to identify the terminal apparatus 100 in a system according to the present embodiment.

The address information 1102 is an address used for communication processing with a terminal apparatus identified by the node ID 1101.

The Electronic Program Guide information table PG111 is stored in the storage unit 120 in a format that allows organization of a plurality of records, each of which is Electronic Program Guide information having a contents ID 1111 to identify contents and information 1112 indicating the broadcasting date and/or time of the contents (see FIG. 17).

The contents management table PG112 is stored in the storage unit 120 in a format that allows organization of a plurality of records, each of which is contents management information having a contents ID 1121 to identify contents, a divided contents ID 1122 to identify divided contents, and state information 1123 indicating validity of the divided contents (see FIG. 18).

The reservation list PG113 is stored in the storage unit 120 in a format that allows organization of a plurality of records, each of which is reservation information having a contents ID 1131 to identify contents and a broadcasting date and time 1132 (see FIG. 19).

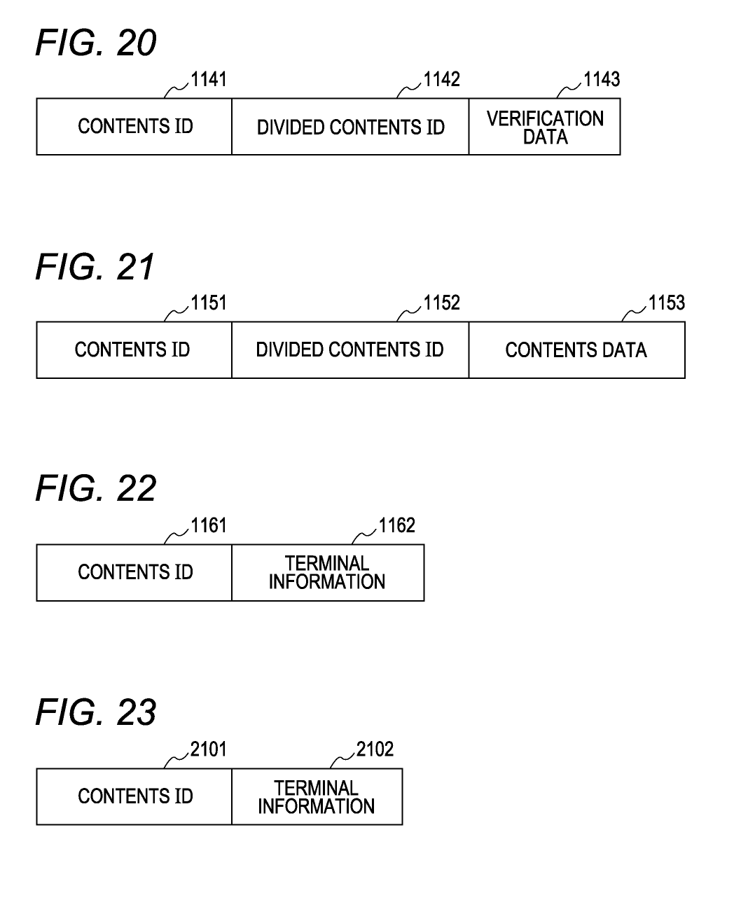

The verification information DB PG114 is stored in the storage unit 120 in a format that allows organization of a plurality of records, each of which is verification information having a contents ID 1141 to identify contents, a divided contents ID 1142 to identify divided contents, and verification data 1143 used for verification processing to judge validity of contents data (see FIG. 20).

The contents DB PG115 is stored in the storage unit 120 in a format that allows organization of a plurality of records, each of which is contents information having a contents ID 1151 to identify contents, a divided contents ID 1152 to identify divided contents, and contents data 1153 made up of images, sound and the like as content of the divided contents (see FIG. 21).

The owning candidate DB PG116 is stored in the storage unit 120 in a format that allows organization of a plurality of records, each of which is owning candidate information having a contents ID 1161 to identify contents and terminal information 1162 indicating information about a terminal apparatus (see FIG. 22).

The terminal information may be any information capable of identifying the terminal apparatus in a system according to the present embodiment.

As the information about the terminal apparatus, for example, the node ID to identify the terminal apparatus or address information indicating the destination when information is transmitted to the terminal apparatus may be used.

Here, as the address information, the IP address, URL, MAC address or the like may be used.

The participation notification unit PG101 is a software component that causes the control unit 110 to operate as a component that transmits a participation notification to notify a system in the present embodiment of the presence of the local terminal, acquires address information of other terminal apparatuses from other terminal apparatuses, and stores the acquired address information in the terminal list PG110.

The reservation registration unit PG102 is a software component that causes the control unit 110 to operate as a component that receives a recording reservation of a broadcast program and registers the received reservation details in the reservation list PG113.

The reservation transmission unit PG103 is a software component that causes the control unit 110 to operate as a component that transmits the received reservation details to another terminal apparatus connected to the system in the present embodiment.

The broadcasting receiving unit PG104 is a software component that causes the control unit 110 to operate as a component that, based on the reservation details registered in the reservation list PG113, receives a broadcast program whose recording reservation is set by using the broadcasting receiving unit 180 and stores contents data supplied from the broadcasting receiving unit 180 in the contents DB PG115.

The verification information receiving unit PG105 is a software component that causes the control unit 110 to operate as a component that receives verification information used to verify whether or not there is any error in contents data by using the communication unit 140 or the broadcasting receiving unit 180 and stores the verification information in the verification information DB PG114.

The verification processing unit PG106 is a software component that causes the control unit 110 to operate as a component that verifies validity of contents data stored in the contents DB PG115 using verification information stored in the verification information DB PG114.

The owning candidate search unit PG107 is a software component that causes the control unit 110 to operate as a component that searches for the location of a terminal apparatus owning complementary information that complements invalid contents data or incomplete contents data.

The complementary processing unit PG108 is a software component that causes the control unit 110 to operate as a component that transmits a request of complementary information to the terminal apparatus retrieved by the owning candidate search unit PG107 via the communication unit 140, receives complementary information transmitted from the terminal apparatus via the communication unit 140, and updates contents data stored in the contents DB PG115 using the received complementary information.

[2-2-2. Overview of the management unit PG200] As illustrated in FIG. 4, the management unit PG200 includes a participation accepting unit PG201, a reservation receiving unit PG202, a search processing unit PG203, and a complementary information transmission unit PG204.

The control unit 110 operating as a component according to the management unit PG200 may also reference the reservation terminal list PG210, the terminal list PG110, the contents management table PG112, and the contents DB PG115.

A reservation terminal list PG210 is stored in the storage unit 120 in a format that allows organization of a plurality of records, each of which is reservation terminal information having a contents ID 2101 to identify contents and terminal information 2102 indicating information about a terminal apparatus (see FIG. 23).

The terminal apparatus information 2102 may be any information capable of identifying the terminal apparatus in a system according to the present embodiment.

As the terminal information, for example, the node ID to identify the terminal apparatus and/or address information indicating the destination when information is transmitted to the terminal apparatus may be used.

Here, as the address information, the IP address, URL, MAC address, or the like may be used.

The participation accepting unit PG201 is a software component that causes the control unit 110 to operate as a component that receives a participation notification transmitted from another terminal apparatus connected to a system according to the present embodiment via the communication unit 140 and sends back details of the terminal list PG110 held in the storage unit 120 via the communication unit 140.

The participation accepting unit PG201 also is a software component that causes the control unit 110 to operate as a component that, based on information indicated in the received participation notification, registers information about the terminal apparatus that has transmitted the participation notification in the terminal list PG110 stored in the storage unit 120.

The reservation receiving unit PG202 is a software component that causes the control unit 110 to operate as a component that receives reservation information transmitted from another terminal apparatus connected to the system according to the present embodiment via the communication unit 140 and updates the reservation terminal list PG210 based on the received reservation information.

That is, the control unit 110 operating as a component according to the reservation receiving unit PG202 associates the contents ID contained in reservation information received from another terminal apparatus via the communication unit 140 with information about the terminal apparatus that has transmitted the reservation information, and stores the associated information in the reservation terminal list PG210.

The reservation receiving unit PG202 is a software component that also causes the control unit 110 to operate as a component that receives reservation information supplied from the request unit PG100 of the local terminal apparatus and updates the reservation terminal list PG210 based on the received reservation information.

That is, the control unit 110 operating as a component according to the reservation receiving unit PG202 associates the contents ID contained in reservation information received by using a technique of inter-process communication or the like from the request unit PG100 executed in the local terminal apparatus with information about the local terminal apparatus, and stores the associated information in the reservation terminal list PG210.

The search processing unit PG203 is a software component that causes the control unit 110 to operate as a component that receives a search request transmitted from another terminal apparatus connected to the system according to the present embodiment via the communication unit 140, references the reservation terminal list PG210 based on the received search request, and acquires the information 2102 about terminal apparatuses satisfying conditions indicated in the received search request from the reservation terminal list PG210.

That is, the control unit 110 operating as a component according to the search processing unit PG203 acquires reservation terminal information corresponding to the contents ID indicated in the search request received via the communication unit 140 from the reservation terminal list PG210.

The search processing unit PG203 is a software component that also causes the control unit 110 to operate as a component that generates a terminal list based on the acquired information 2102 about the terminal apparatuses and transmits the generated terminal list to the terminal apparatus that has transmitted the search request via the communication unit 140.

That is, the control unit 110 operating as a component according to the search processing unit PG203 transmits a terminal list generated based on the terminal information 2102 acquired from the reservation terminal list PG210 via the communication unit 140.

The search processing unit PG203 is a software component that also causes the control unit 110 to operate as a component that receives a search request supplied from the request unit PG100 of the local terminal apparatus and performs search processing based on the received search request and transmission processing of the terminal list.

That is, the control unit 110 operating as a component according to the search processing unit PG203 performs search processing and transmission processing of the terminal list based on the received search request received by using a technique of inter-process communication or the like from the request unit PG100 executed in the local terminal apparatus.

The complementary information transmission unit PG204 is a software component that causes the control unit 110 to operate as a component that acquires contents data corresponding to the contents ID and divided contents ID indicated in a transmission request of complementary information received from another terminal apparatus connected to the system according to the present embodiment from the contents DB PG115 held in the storage unit 120.

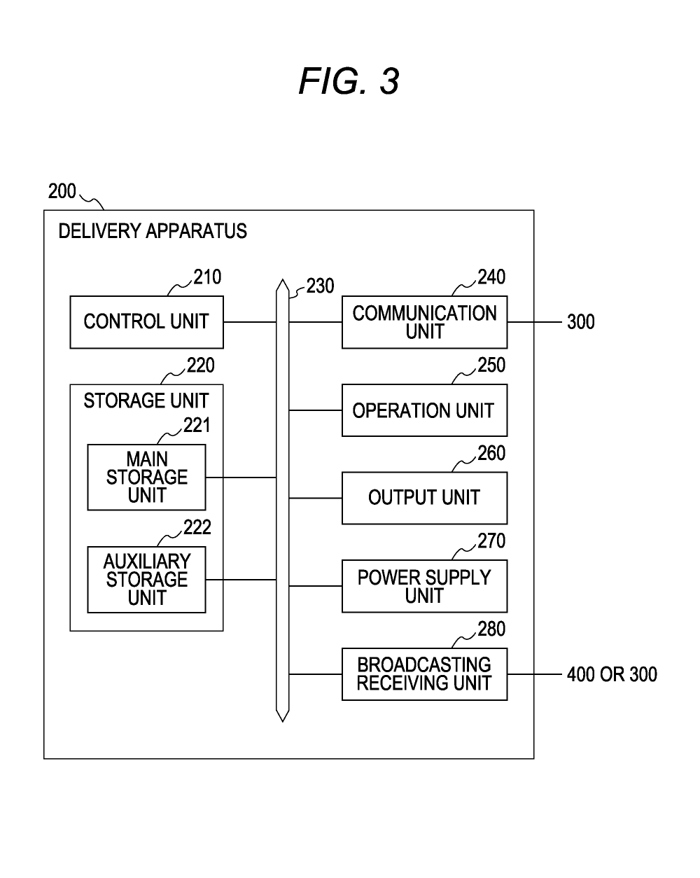

The complementary information transmission unit PG204 also is a software component that causes the control unit 110 to operate as a component that transmits complementary information to the terminal apparatus that has transmitted the transmission request.

[3. Configuration of the delivery apparatus] [3-1. Hardware configuration of the delivery apparatus] FIG. 3 illustrates the hardware configuration of the delivery apparatus 200 according to the present embodiment.

The delivery apparatus 200 illustrated in FIG. 3 includes a control unit 210, a storage unit 220, a communication unit 240, an operation unit 250, an output unit 260, a power supply unit 270, and a broadcasting transmitting unit 280, and these units are communicably connected via a communication line 230.

The control unit 210 is a unit that realizes functions according to procedures of programs stored in the storage unit 220, and is connected to each unit of hardware of the terminal apparatus via the communication line 230.

As the control unit 210, for example, a CPU (Central Processing Unit), MPU (Micro Processing Unit), or the like may be used.

The broadcasting transmitting unit 280 is a unit that transmits, through the broadcasting transmitting unit 280, contents data of various programs and verification information to the nodes in the system.

The broadcasting transmitting unit 280 is connected to broadcasting equipment 400 that outputs radio waves for broadcasting via a dedicated line or the like.

The broadcasting transmitting unit 280 may also be connected to a communication line 300 such as the Internet to transmit contents data of various programs and verification information via the communication line 300 such as the Internet.

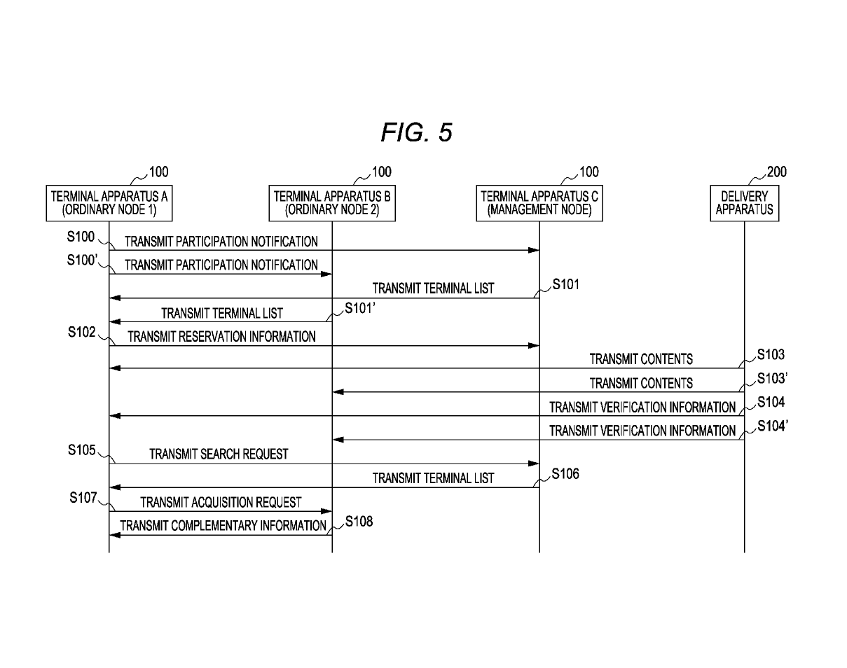

Other components of the hardware configuration of the delivery apparatus 200 are the same as those of a general personal computer or the like and thus, a detailed description thereof is omitted.

[4. Flow of processing of the overall system] FIG. 5 illustrates the processing flow of a system according to the present embodiment.

The example in FIG. 5 illustrates the flow of processing when a terminal apparatus A (100) participates in a system according to the present embodiment and the terminal apparatus A (100) receives contents from the system according to the present embodiment.

[4-1. Participation in a P2P system] First, the terminal apparatus A transmits a participation notification to notify the presence of the local terminal in a system to other terminal apparatuses connected to the system (S100 and S100′).

That is, the control unit 110 operating as a component according to the participation notification unit PG101 held by the request unit PG100 illustrated in FIG. 4 outputs a signal indicating a participation notification to the communication line 300 using the communication unit 140.

For example, the terminal apparatus A transmits a signal indicating a participation notification to an indefinite number of terminal apparatuses communicably connected via the communication line 300.

Here, broadcast technology, multicast technology, and the like may be used in an IP network (Internet Protocol Network) for transmission processing of a signal to an indefinite number of terminal apparatuses.

A terminal apparatus B and a terminal apparatus C that receive the signal indicating a participation notification from the terminal apparatus A transmit the terminal list (PG110) stored in the storage unit 120 held by the terminal apparatus B and C to the terminal apparatus A (S101 and S101′).

That is, with the control unit 110 operating as a component according to the participation accepting unit PG201 held by the management unit PG200 illustrated in FIG. 4, if a received message acquired from the communication unit 140 via the communication line 130 is a signal indicating a participation notification, the control unit 110 transmits details registered in the terminal list PG110 stored in the storage unit 120 to the terminal apparatus that has transmitted the participation notification.

When a terminal list stored in the storage unit 120 is transmitted, each terminal apparatus may transmit information on the local terminal apparatus with the terminal list.

Each terminal apparatus may also store information about the local terminal apparatus in the terminal list stored in the storage unit 120, in addition to the addition thereof to the terminal list.

FIG. 11 illustrates an example of a terminal list transmitted from the terminal apparatus C.

The terminal list illustrated in FIG. 11 includes the node ID 1101 indicating information for identifying the terminal apparatus in a P2P system and the address information 1102 used as information for identifying the transmission destination or transmission source terminal apparatus when communication is performed via the communication line 300.

The example in FIG. 11 illustrates that the terminal apparatus C participates in the system according to the present embodiment before the participation notification is received from the terminal apparatus A and has acquired the node ID and address information of the terminal apparatus B that similarly participates in the system.

Here, the node ID may be any information capable of identifying each of the terminal apparatuses 100 in the system according to the present embodiment.

For example, a hash value obtained by hashing a serial number, machine name, or the like assigned in advance when shipped from a factory by using a common hash function may be used as the node ID.

By using the hash value as information to identify the terminal apparatus in the system according to the present embodiment, terminal apparatuses participating in the system according to the present embodiment may be managed based on the magnitude or the like of the hash value.

For example, by using a hash function whose number of generating digits is 128 bits, as many as about 340×10̂36 terminal apparatus, which is the 128-th power of 2, may be managed in the system according to the present embodiment.

The terminal apparatus A aggregates terminal lists received from each terminal apparatus and stores the aggregated terminal list in the storage unit 120.

That is, with the control unit 110 operating as a component according to the participation notification unit PG101 held by the request unit PG100 illustrated in FIG. 4, the control unit 110 aggregates terminal lists received from each terminal apparatus and registers the aggregated terminal list in the terminal list PG110 held in the storage unit 120.

[4-2. Reservation processing] Next, when an instruction to make a reservation to receive delivery of contents by an input operation of the operator is received, the terminal apparatus A stores reservation details in the storage unit 120 and transmits reservation information indicating the reservation details to the management node identified based on the reserved contents (S102).

That is, with the control unit 110 operating as a component according to the reservation registration unit PG102 held by the request unit PG100 illustrated in FIG. 4, the control unit 110 registers reservation details in the reservation list PG113 held by the storage unit 120.

Also, with the control unit 110 operating as a component according to the reservation transmission unit PG103 held by the request unit PG100, the control unit 110 transmits reservation information via the communication unit 140.

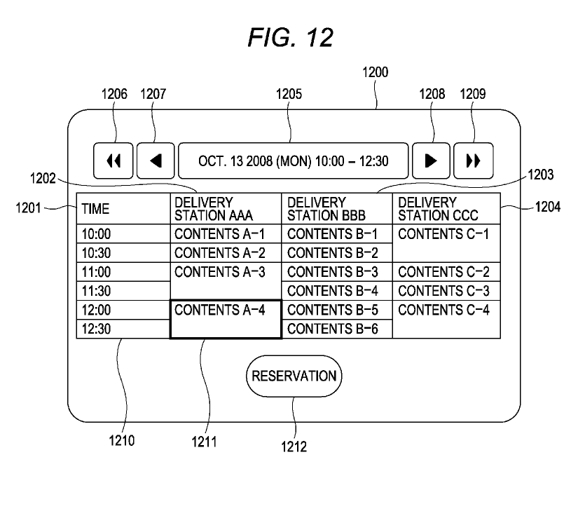

FIG. 12 illustrates an example of a reservation screen that displays a reservation operation in the terminal apparatus.

In a reservation screen 1200 illustrated in FIG. 12, a contents delivery schedule table 1210 including a time 1201 which indicates starting time of contents, a delivery station AAA 1202, a delivery station BBB 1203, and a delivery station CCC 1204 are displayed. The delivery station MA 1202, the delivery station BBB 1203, and the delivery station CCC 1204 illustrated in FIG. 12 are examples of broadcast stations which broadcast contents.

In the example illustrated in FIG. 12, the operator of the terminal apparatus may input a reservation instruction of desired contents A-4 into the terminal apparatus by selecting the contents A-4 (1211) indicated in the reservation screen 1200 and pressing a reservation button 1212.

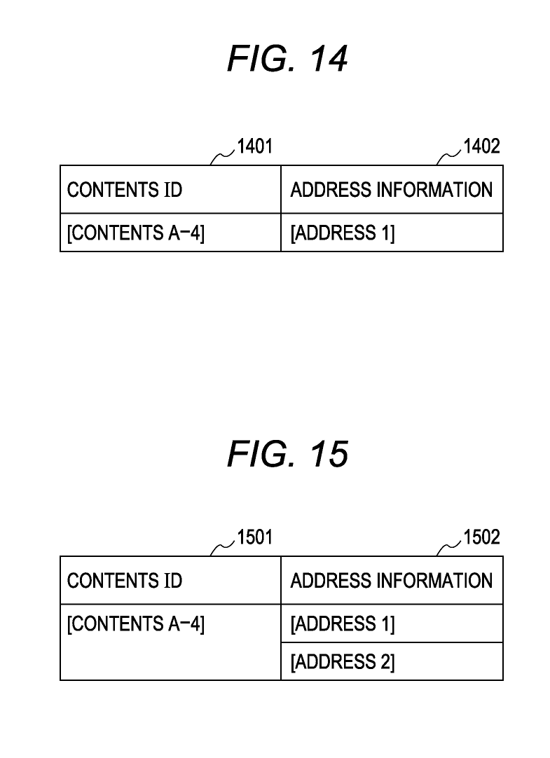

FIG. 14 illustrates an example of the reservation information transmitted from the terminal apparatus A.

The reservation information illustrated in FIG. 14 includes a contents ID 1401 and address information 1402.

The contents ID 1401 may be any information capable of identifying contents in a system according to the present embodiment.

For example, a hash value obtained by hashing information such as the name given to the contents by a delivery station of the contents and data length of the contents by using a common hash function may be used as the contents ID.

The address information 1402 is information indicating the address of the terminal apparatus that transmits the reservation information and, for example, the IP address, URL, or MAC address may be used as the address information 1402.

In the example illustrated in FIG. 14, information identifying the contents A-4 is illustrated as the contents ID 1401 and information indicating the address of the terminal apparatus A is illustrated as the address information 1402.

When the system according to the present embodiment uses the hash value in order to identify contents in the system according to the present embodiment, the system may efficiently manage a lot of contents by using the magnitude of the hash value.

Further, when the system uses the hash value in order to identify contents and to identify the terminal apparatus in the system, the magnitude of the hash value as a contents ID and that of the hash value as a terminal apparatus ID may be compared.

In the example illustrated in FIG. 5, the terminal apparatus A transmits reservation information indicating details of the reservation instruction to the terminal apparatus C as the management node determined based on the contents whose reservation instruction is accepted (S102).

For example, by comparing the magnitude of the contents ID of contents whose reservation instruction is accepted and that of the terminal ID registered in the terminal list, the terminal apparatus whose contents ID and terminal ID are nearest (the difference is the smallest value) may be determined as the management node.

When, instead of the hash value, character type data in which alphabetical characters and symbols are mixed is used as the contents ID and terminal ID, the magnitude thereof may be compared by using a character code such as ASCII (American Standard Code for Information Interchange) and/or Unicode.

The terminal apparatus C updates the reservation terminal list stored in the storage unit 120 based on reservation information received from the terminal apparatus A.

FIG. 15 illustrates an example of the reservation terminal list stored in the terminal apparatus C.

The reservation terminal list illustrated in FIG. 15 includes a contents ID 1501 and address information 1502.

The contents ID 1501 is registered based on the contents ID 1401 contained in the received reservation information.

The address information 1502 is registered based on the address information 1402 contained in the received reservation information.

The example in FIG. 15 illustrates that information to identify the contents A-4 is registered as the contents ID 1501, and an address 1 of the terminal apparatus A and an address 2 of the terminal apparatus B are registered as information indicating addresses of terminal apparatuses that have transmitted reservation information for the contents A-4.

[4-3. Delivery processing] Next, the terminal apparatus A receives contents whose reservation instruction is accepted from the delivery apparatus 200 and stores the received contents data in the contents DB PG115 by associating with the contents ID with the divided contents ID (S103).

That is, with the control unit 110 operating as a component according to the broadcasting receiving unit PG104 held by the request unit PG100 illustrated in FIG. 4, the control unit 110 registers contents received via the communication unit 140 in the contents DB PG115 held in the storage unit 120.

The trigger for performing reception processing of contents data may be linked, for example, to the arrival of the time when contents whose reservation instruction is accepted is delivered from the delivery apparatus.

In this case, the terminal apparatus may acquire the delivery time to be linked from Electronic Program Guide information.

Further, the terminal apparatus A receives verification information of contents whose reservation instruction is accepted from the delivery apparatus 200 and stores the received verification information in the verification information DB PG114 by associating the contents ID with the divided contents ID (S104).

That is, with the control unit 110 operating as a component according to the verification information receiving unit PG105 held by the request unit PG100, the control unit 110 registers verification information received via the communication unit 140 in the verification information DB PG114 held in the storage unit 120.

It is not always necessary to link the trigger for performing reception processing of verification information with the above delivery time.

For example, the terminal apparatus receives verification information repeatedly transmitted by associating the contents ID with the divided contents ID by a data carousel transmission method at an appropriate timing.

That is, the terminal apparatus may receive verification information together with contents data or before or after receiving contents data.

In the example illustrated in FIG. 5, the reception processing of contents data and verification information are performed also by the terminal apparatus B (S103′ and S104′).

That is, the contents DB PG115 held by the terminal apparatus B has contents data having the same contents ID as that of the contents received by the terminal apparatus A in the above processing S103 stored therein.

However, the terminal apparatus A and the terminal apparatus B may have different content of contents data stored in the contents DB PG115.

This may occur if the weather is different at the installation locations of both terminal apparatuses when, for example, the weather in a region where the terminal apparatus A is installed is torrential rain during reception while the weather in a region where the terminal apparatus B is installed is fine weather during reception.

That is, if the weather of a region where a terminal apparatus is installed is torrential rain, reception sensitivity deteriorates due to rain attenuation and, as a result, content of contents data may become incomplete or an erroneous value may arise in the data.

In addition to the weather, noise may be entrapped due to a malfunction of equipment of the terminal apparatus, resulting in content of contents data which is different from original values.

[4-4. Verification processing] Next, the terminal apparatus A performs verification processing of the contents data stored in the contents DB PG115 using the received verification information.

That is, the control unit 110 operating as the verification processing unit PG106 held by the request unit PG100 illustrated in FIG. 4 performs verification processing of the contents registered in the contents DB PG115 held in the storage unit 120 using verification information registered in the verification information DB PG114 held in the storage unit 120.

The terminal apparatus A performs processing to acquire complementary information for locations judged not to be appropriate as a result of performing search processing.

First, the terminal apparatus A transmits a search request to obtain the location of a terminal apparatus owning complementary information for applicable locations to the terminal apparatus C operating as the management node (S105).

That is, the control unit 110 operating as the owning candidate search unit PG107 held by the request unit PG100 illustrated in FIG. 4 transmits a signal indicating a search request via the communication unit 140.

Here, the search request transmitted from the terminal apparatus A has the contents ID of contents judged not to be appropriate in the above verification.

The terminal apparatus C acquires reservation terminal information corresponding to the contents ID indicated in the received search request from the reservation terminal list PG210.

The terminal apparatus C transmits a terminal list generated based on the acquired reservation terminal information to the terminal apparatus A that has transmitted the search request (S106).

That is, the control unit 110 operating as the search processing unit PG203 held by the management unit PG200 illustrated in FIG. 4 acquires reservation terminal information registered in the reservation terminal list PG210 held in the storage unit 120 and transmits the acquired reservation terminal information via the communication unit 140.

The terminal apparatus A transmits an acquisition request to acquire complementary information of contents to the terminal apparatus indicated in the received terminal list (S107).

That is, the control unit 110 operating as the complementary processing unit PG108 held by the request unit PG100 illustrated in FIG. 4 transmits a signal indicating an acquisition request via the communication unit 140.

Here, the acquisition request transmitted from the terminal apparatus A has the contents ID to identify contents and divided contents ID.

The terminal apparatus B acquires divided contents data corresponding to the contents ID and divided contents ID indicated in the received acquisition request from the contents DB PG115.

The terminal apparatus B transmits the acquired divided contents data to the terminal apparatus A that has transmitted the acquisition request as complementary information (S108).

That is, the control unit 110 operating as the complementary information transmission unit PG204 held by the management unit PG200 illustrated in FIG. 4 acquires complementary information by referencing the contents DB PG115 held in the storage unit 120 and transmits the acquired complementary information via the communication unit 140.

Here, complementary information transmitted from the terminal apparatus B has the contents ID to identify contents, divided contents ID, and divided contents data.

The terminal apparatus A updates divided contents data stored in the contents DB PG115 by associating the contents ID with the divided contents ID indicated in the received complementary information using the divided contents data included in the received complementary information.

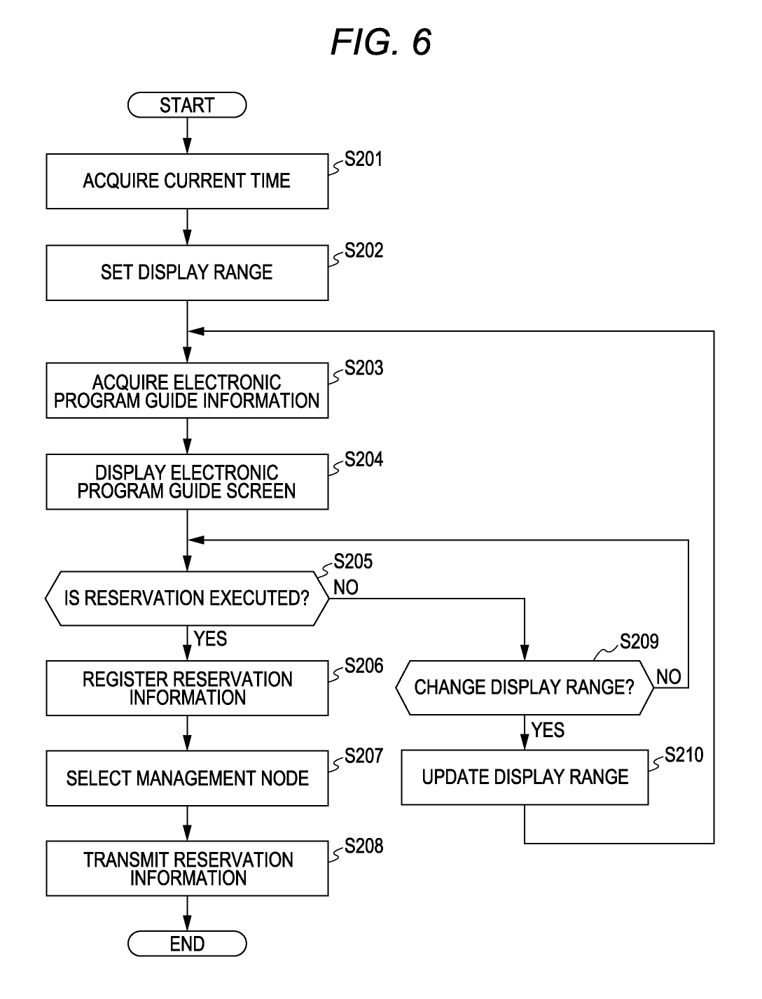

The foregoing is the flow of overall processing of a system according to the present embodiment.

[5. Flow of reservation processing in the request unit PG100] Next, a procedure for reservation processing in the request unit PG100 performed by the terminal apparatus 100 will be described using FIG. 6.

FIG. 6 illustrates a processing procedure for reservation processing in the request unit PG100 performed by the terminal apparatus.

The processing procedure illustrated in FIG. 6 is performed by the control unit 110 operating as the reservation registration unit PG102 or the reservation transmission unit PG103 held by the request unit PG100 illustrated in FIG. 4.

First, the control unit 110 of the terminal apparatus acquires the current date and time from a system clock (not shown) or the like (S201) and sets the display range of Electronic Program Guide based on the acquired date and time (S202).

Here, a range of time starting from the acquired date/time may be set as the display range.

For example, if the current date and time is “Oct. 13, 2008, 10:00” and the range of time is “three hours”, the start point of the display range is “Oct. 13, 2008, 10:00” and the end point of the display range is “Oct. 13, 2008, 13:00”.

Next, the control unit 110 references the Electronic Program Guide information table PG111 to acquire Electronic Program Guide information corresponding to the display range set in the above processing S202 (S203) and displays an Electronic Program Guide screen based on the acquired Electronic Program Guide information (S204).

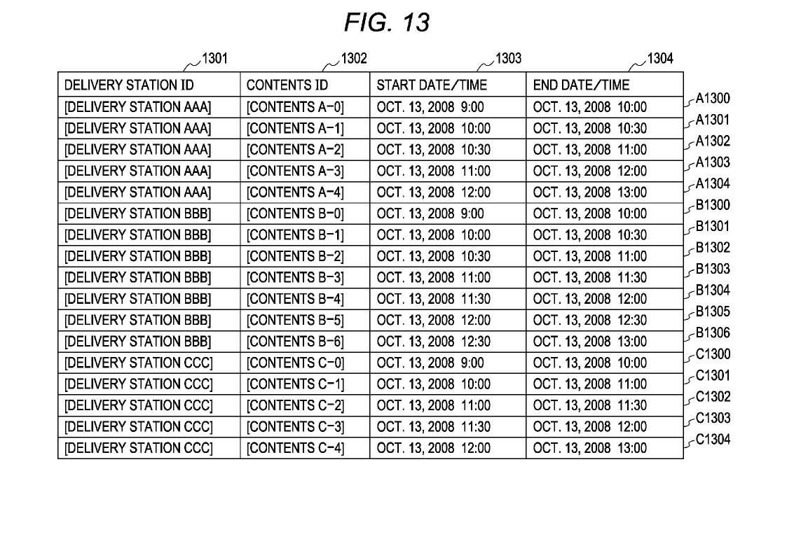

FIG. 13 illustrates an example of the Electronic Program Guide information table PG111.

Electronic Program Guide information stored in the Electronic Program Guide information table PG111 illustrated in FIG. 13 has a delivery station ID 1301, a contents ID 1302, a start date/time 1303, and an end date/time 1304.

The control unit 110 references the start date/time 1303 and the end date/time 1304 included in the Electronic Program Guide information stored in the Electronic Program Guide information table PG111 in the above processing S203 to compare the time zone indicated by the start date/time 1303 and the end date/time 1304 and the display range set in the above processing S202.

If, as a result of comparison, the time zone indicated by the start date/time 1303 and the end date/time 1304 and the display range set in the above processing S202 overlap at least partially, the control unit 110 judges that the display range is applicable.

In the example illustrated in FIG. 13, if the display range is set with the start point “Oct. 13, 2008, 10:00” and the end point “Oct. 13, 2008, 13:00”, Electronic Program Guide information applicable to the display range includes Electronic Program Guide information A1301 to A1304, Electronic Program Guide information B1301 to B1306, and Electronic Program Guide information C1301 to C1304.

That is, as illustrated in FIG. 13, Electronic Program Guide information A1300, Electronic Program Guide information B1300, and Electronic Program Guide information C1300 have no overlap with the time zone set as the display range and are judged not to be applicable to the display range and excluded from acquisition targets in the above processing S203.

FIG. 12 illustrates an example of an Electronic Program Guide screen displayed in the terminal apparatus.

The Electronic Program Guide screen illustrated in FIG. 12 displays the Electronic Program Guide list 1210 including the time 1201, the delivery station AAA (1202), the delivery station BBB (1203), and the delivery station CCC (1204), a display range notification field 1205, display range change instruction units 1206 to 1209, a program selection unit 1211, and the reservation instruction unit 1212.

The display range notification field 1205 illustrated in FIG. 12 indicates that the display range of the Electronic Program Guide information displayed in the Electronic Program Guide list 1210 is “Oct. 13, 2008, 10:00” as the start point and “Oct. 13, 2008, 12:30” as the end point.

The Electronic Program Guide list 1210 illustrated in FIG. 12 indicates that “Contents A-1” is delivered in the time zone “10:00 to 10:30”, “Contents A-2” in the time zone “10:30 to 11:00”, “Contents A-3” in the time zone “11:00 to 12:00”, and “Contents A-4” in the time zone “12:00 to 13:00” as programs delivered by the delivery station AAA (1202).

In the Electronic Program Guide list 1210 illustrated in FIG. 12, the delivery station BBB (1203) and the delivery station CCC (1204) are similar to the delivery station AAA (1202) and thus, a description thereof is omitted.

If a detection signal indicating that an input operation has been performed in the Electronic Program Guide screen is received from the operation unit 150, the control unit 110 judges whether or not the input operation is a press of the reservation instruction unit 1212 (S205).

If the control unit 110 judges that the input operation is a press of the reservation instruction unit 1212 in the above judgment processing at S205 (YES at S205), the control unit 110 performs registration processing of reservation information (S206).

That is, the control unit 110 acquires Electronic Program Guide information indicating a program selected by the program selection unit 1211, generates reservation information based on the acquired Electronic Program Guide information, and registers the reservation information in the reservation list PG113 (S206).

The example illustrated in FIG. 12 indicates that the program selection unit 1211 has selected the program “contents A-4” of “delivery station AAA”.

The control unit 110 generates reservation information having the contents ID 1302 indicated in the Electronic Program Guide information and registers the reservation information in the reservation list PG113.

At this point, the broadcasting date/time 1112 (the start date/time 1303 and the end date/time 1304) acquired from the Electronic Program Guide information may be registered as reservation information, or the broadcasting date/time 1112 (the start date/time 1303 and the end date/time 1304) may be acquired from the Electronic Program Guide information each time reservation information is referenced.

Next, the control unit 110 decides the terminal apparatus to be set as a transmission destination of reservation information based on the contents ID indicated in the Electronic Program Guide information acquired in the above processing S206 (S207).

The control unit 110 compares the contents ID 1302 indicated in the Electronic Program Guide information acquired in the above processing S206 and the node ID 1101 registered in the terminal list PG110 to acquire the node ID 1101 having the value nearest to the value of the contents ID 1302.

The control unit 110 acquires the address information 1102 corresponding to the acquired node ID from the terminal list PG110 (S207).

The control unit 110 uses the address of the terminal apparatus 100 indicated in the acquired address information 1102 to transmit the contents ID acquired from the Electronic Program Guide information table PG111 in the above processing S206 and the reservation information having address information or node ID allocated to the local terminal apparatus (S208).

The control unit 110 may also use the technique of inter-process communication or the like to transmit reservation information to the management unit PG200 performed by the local terminal apparatus (S208).

If, on the other hand, the control unit 110 judges that the input operation is not a press of the reservation instruction unit 1212 in the above judgment processing at S205 (NO at S205), the control unit 110 judges whether the input operation is a press of the display range change instruction units 1206 to 1209 indicating a change instruction of the display range (S209).

In the example illustrated in FIG. 12, the display range change instruction unit 1206 is used to input an instruction to move the display range backward by, for example, one day, the display range change instruction unit 1207 to input an instruction to move the display range backward by, for example, one hour, the display range change instruction unit 1208 to input an instruction to move the display range forward by, for example, one hour, and the display range change instruction unit 1209 to input an instruction to move the display range forward by, for example, one day.

If the control unit 110 judges that the input operation is a press of the display range change instruction units 1206 to 1209 indicating a change instruction of the display range (YES at S209), the control unit 110 updates the display range depending on which display range change instruction unit 1206 to 1209 is pressed (S210).

If, on the other hand, the control unit 110 judges that the input operation is not a press of the display range change instruction units 1206 to 1209 indicating a change instruction of the display range (NO at S209), the control unit 110 performs processing of the above processing S205 and thereafter.

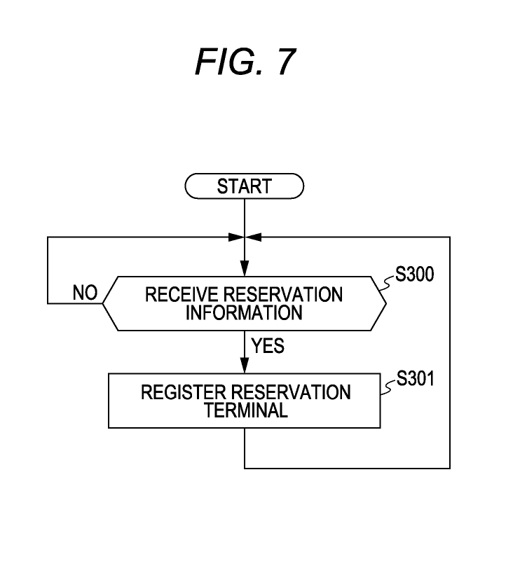

The foregoing is the flow of reservation processing by the request unit PG100 performed by a terminal apparatus according to the present embodiment.

[6. Flow of reservation processing in the management unit PG200] Next, a procedure for reservation processing in the management unit PG200 performed by a terminal apparatus will be described using FIG. 7.

FIG. 7 is a diagram illustrating a procedure for reservation processing in the management unit PG200 performed by the terminal apparatus.

The processing procedure illustrated in FIG. 7 is performed by the control unit 110 operating as the reservation receiving unit PG202 held by the management unit PG200 illustrated in FIG. 4.

First, the control unit 110 of the terminal apparatus judges whether reception of reservation information is detected (S300).

If the control unit 110 analyzes a received message acquired from the communication unit 140 via the communication line 130 and judges that the received message indicates reservation information, the control unit 110 judges that reception of reservation information is detected (YES at S300).

If the control unit 110 analyzes a received message acquired from the request unit PG100 performed by the local terminal apparatus using the technique of inter-process communication or the like and judges that the received message indicates reservation information, the control unit 110 may also judge that reception of reservation information is detected (YES at S300).

If reception of reservation information is detected (YES at S300), the control unit 110 acquires the received reservation information from the communication unit 140 and registers reservation terminal information in the reservation terminal list PG210 based on the acquired reservation information (S301).

That is, the control unit 110 registers reservation terminal information having the contents ID 2101 and the terminal information 2102 in the reservation terminal list PG210 based on the contents ID and terminal information indicated in the reservation information.

Here, the terminal information 2102 may be a node ID or address information.

The control unit 110 performs the above processing S300 after performing registration processing of the reservation terminal information.

If the control unit 110 judges in the above processing S300 that reception of reservation information is not detected (NO at S300), the control unit 110 performs the processing S300 again after a certain time has passed.

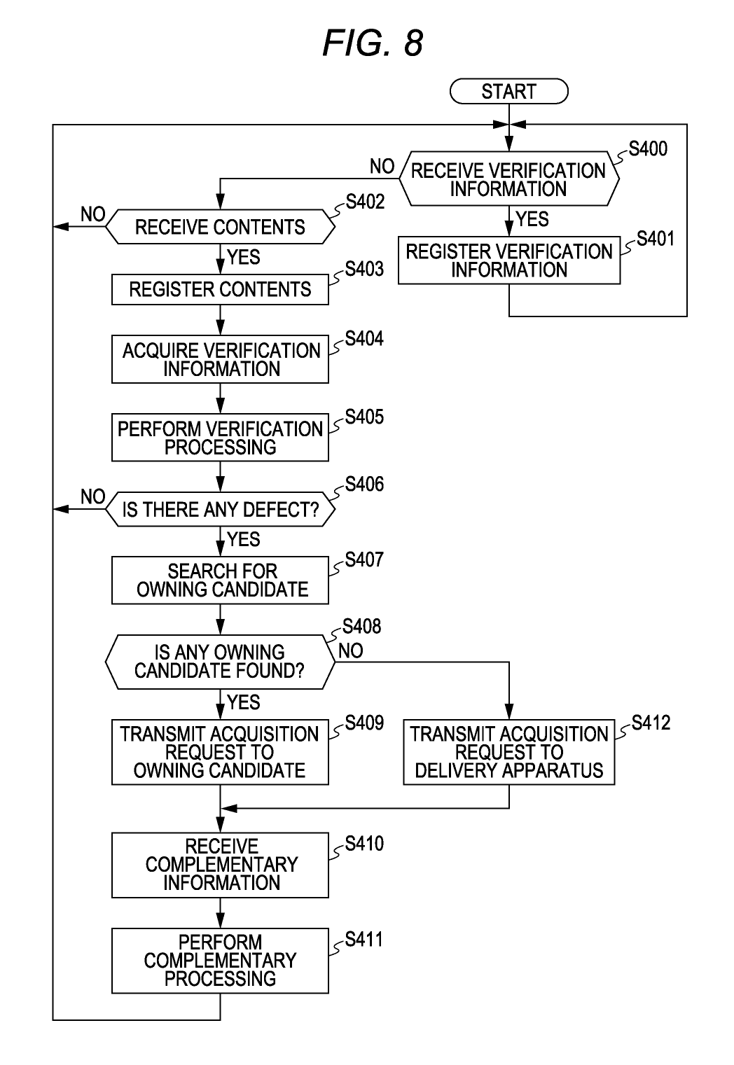

The foregoing is the flow of reservation processing in the management unit PG200 performed by the terminal apparatus 100 according to the present embodiment.

[7. Recording processing in the request unit PG100] Next, a procedure for recording processing in the request unit PG100 performed by the terminal apparatus 100 will be described using FIG. 8.

FIG. 8 illustrates the flow of recording processing in the request unit PG100 performed by the terminal apparatus 100.

The processing procedure illustrated in FIG. 8 is performed by the control unit 110 functioning as the broadcasting receiving unit PG104, the verification information receiving unit PG105, the verification processing unit PG106, the owning candidate search unit PG107, the complementary processing unit PG108, or the like held by the request unit PG100 illustrated in FIG. 4.

First, the control unit 110 of the terminal apparatus judges whether verification information is received (S400).

If the control unit 110 analyzes a received message acquired from the communication unit 140 via the communication line 130 and judges that the received message indicates verification information, the control unit 110 judges that verification information is received (YES at S400).

If the control unit 110 judges that verification information is received (YES at S400), the control unit 110 registers the received verification information in the verification information DB PG114.

As illustrated in FIG. 20, the verification information includes the contents ID 1141, the divided contents ID 1142, and verification data 1143.

As the verification data, for example, a hash value obtained by hashing contents data divided into certain time units may be used.

If the control unit 110 judges in the above processing S400 that no verification information is received (NO at S400), the control unit 110 judges whether or not contents are received (S402).

If the control unit 110 analyzes a received message acquired from the communication unit 140 via the communication line 130 and judges that the received message indicates contents information, the control unit 110 judges that contents are received (YES at S402).

If the control unit 110 judges that contents information is received (YES at S402), the control unit 110 registers the received contents information in the contents DB PG115 and contents management information indicating a state of the received contents information in the contents management table (PG112) (S403).

As illustrated in FIG. 21, the contents information includes the contents ID 1151, the divided contents ID 1152, and the contents data 1153.

The contents data 1153 is contents data obtained by dividing contents identified by the contents ID 1151 into predetermined time units or the like.

As illustrated in FIG. 18, the contents management information includes the contents ID 1121, the divided contents ID 1122, and the state information 1123.

The state information 1123 indicates a result of verification processing performed on contents data included in the contents information.

The state information 1123 has, for example, a value indicating “not verified” before verification processing being performed stored therein.

If, as a result of performing verification processing, consistency with the verification information is found, a value indicating “consistent” is stored, and if no consistency with the verification information is found, a value indicating “not consistent” is stored.

Contents information received by the radio receiver 500 may not have the divided contents ID.

In this case, contents data included in contents information received by the radio receiver 500 may be reconfigured into units for verification processing with the sequence number indicating the reconfigured order attached by the terminal apparatus 100.

That is, in this example, the above sequence number may be used as the divided contents ID included in contents information and verification information.

Next, the control unit 110 acquires verification information corresponding to the contents ID and divided contents ID included in the contents information registered in the contents DB PG115 in the above processing S403 from the verification information DB PG114 (S404).

The control unit 110 uses the verification data 1143 included in the acquired verification information to perform verification processing of consistency of contents data included in the contents information.

The control unit 110 compares, for example, a hash value generated from the contents data using the same algorithm as that used for generating verification data with the verification data and if both values match, the control unit 110 may judge that the contents data is consistent (No at S406).

That is, if the control unit 110 judges that the contents data is not defective (NO at S406), the control unit 110 performs processing in the above processing S400 and thereafter.

On the other hand, if, as a result of performing the above processing S405, the control unit 110 judges that the contents data is defective (YES at S406), the control unit 110 searches for an owning candidate indicating a terminal apparatus that may have data to complement the defects (S407).

An example of search processing in the processing S407 will be described later.

The control unit 110 judges, as a result of performing search processing, whether or not an owning candidate is found (S408)

If, as a result of performing the above search processing, the control unit 110 judges that an owning candidate is obtained (YES at S408), the control unit 110 transmits an acquisition request to request transmission of complementary information to the terminal apparatus indicated by an owning candidate acquired by the above search processing (S409).

Here, the acquisition request transmitted to the terminal apparatus indicated by an owning candidate includes the contents ID and divided contents ID corresponding to the contents data judged to be defective in the above verification processing.

Data organized in a list form indicating a plurality of terminal apparatuses may be used as owning candidates acquired in the above search processing (S407).

In this case, the control unit 110 may select terminal apparatuses indicated in the owning candidate list in any order to sequentially transmit an acquisition request to these terminal apparatuses, or multicasting may be used (S409).

On the other hand, if the control unit 110 judges in the above processing S408 that acquisition of an owning candidate failed (NO at S408), the control unit 110 transmits an acquisition request to request transmission of complementary information to the delivery apparatus 200 (S412).

Here, the acquisition request transmitted to the delivery apparatus 200 includes the contents ID and divided contents ID corresponding to the contents data judged to be defective in the above verification processing.

The control unit 110 receives complementary information from the transmission destination of the acquisition request (S410) and performs complementary processing using the received complementary information (S411).

Here, the complementary information received from the transmission destination of the acquisition request includes the contents ID, divided contents ID, and the contents data.

That is, in the above complementary processing, the control unit 110 searches the contents DB PG115 for contents information corresponding to the contents ID and divided contents ID in the received complementary information.

Then, the control unit 110 updates contents data included in the searched contents information by using contents data included in the received complementary information.

If the transmission destination of the acquisition request does not own consistent contents data, the control unit 110 receives incomplete complementary information in the above processing S410.

In this case, the control unit 110 discards the complementary information without performing the above processing S411 and may perform reception processing of complementary information from the terminal apparatus of another owning candidate or from the delivery apparatus.

The foregoing is the flow of recording processing in the request unit PG100 performed by the terminal apparatus 100.

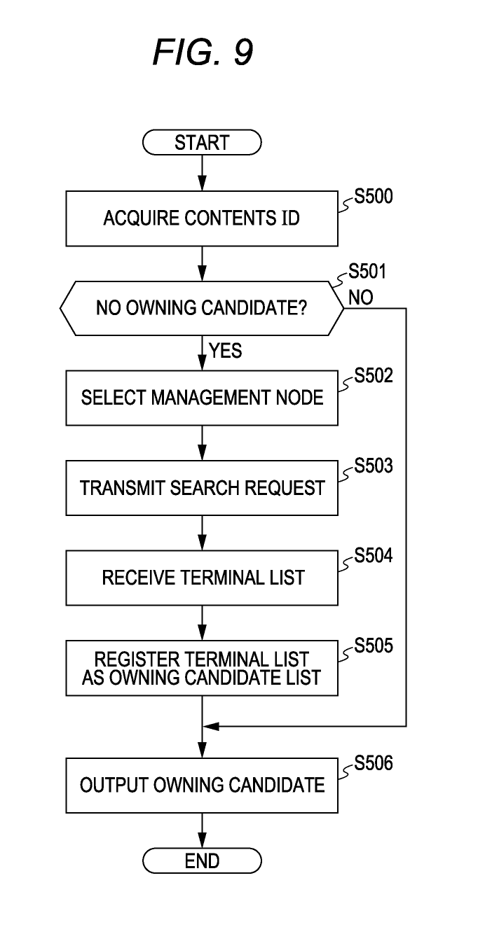

In the above example, recording processing using the terminal apparatus 100 is described and the above complementary processing may be performed when delivered contents are reproduced.

[8. Owning candidate search processing in the request unit PG100] Next, a procedure for owning candidate search processing performed in the above processing S407 will be described using FIG. 9.

FIG. 9 illustrates the flow of owning candidate search processing in the request unit PG100 performed by the terminal apparatus.

The processing procedure illustrated in FIG. 9 is performed by the control unit 110 operating as an owning candidate search unit PG107 held by the request unit PG100 illustrated in FIG. 4.

First, the control unit 110 starts owning candidate search processing by specifying the contents ID. In step S500 of owning candidate search processing, the control unit 110 acquire the specified contents ID (S500).

Here, the contents ID is the contents ID corresponding to the contents data judged to be defective by the verification processing performed in the above processing S405.

The control unit 110 judges whether or not owning candidate information is present (S501).

If, for example, the control unit 110 has acquired owning candidate information from the management unit PG200 performed by the local terminal apparatus or another terminal apparatus, the control unit 110 judges that owning candidate information is present (NO at S501).

If the control unit 110 judges in the above processing S501 that an owning candidate is present (NO at S501), the control unit 110 outputs owning candidate information already held as a search result (S506).

On the other hand, if the control unit 110 judges in the above processing S501 that an owning candidate is not present (YES at S501), the control unit 110 performs selection processing of the management node (S502).

For example, the control unit 110 compares the contents ID acquired in the above processing S500 and the node ID 1101 registered in the terminal list PG110 to select the node ID 1101 having the value nearest to that of the contents ID.

The control unit 110 acquires the address information 1102 corresponding to the acquired node ID from the terminal list PG110 (S502).

The control unit 110 transmits a search request containing the contents ID acquired in the above processing S500 to the terminal apparatus indicated in the acquired address information 1102 (S503).

The control unit 110 may also transmit a search request to the management unit PG200 performed by the local terminal apparatus by using a technique such as inter-process communication (S503).

The control unit 110 receives a terminal list as a search result from the transmission destination of the search request (S504) and registers the received terminal list in the owning candidate DB PG116 (S505).

The terminal list received in the above processing S504 includes the contents ID and terminal information.

The terminal information may be a node ID or address information.

If the node ID is used as the terminal information, the address information 1102 may be acquired by referencing the terminal list PG110.

The control unit 110 outputs the terminal list received in the above processing S504 as a list of owning candidates (S506).

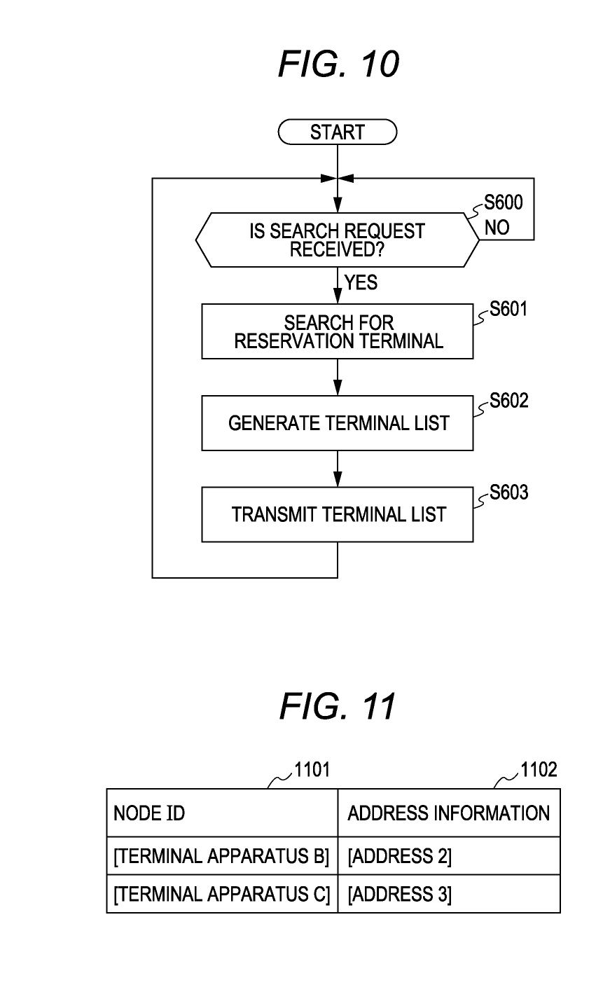

The foregoing is the flow of search processing in the request unit PG100 performed by the terminal apparatus 100 according to the present embodiment.

[9. Owning candidate search processing in the management unit PG200] Next, a procedure for owning candidate search processing performed by the terminal apparatus 100 that receives a search request transmitted in the above processing S503 will be described using FIG. 10.

FIG. 10 illustrates the flow of owning candidate search processing in the management unit PG200 performed by the terminal apparatus.

The processing procedure illustrated in FIG. 10 is performed by the control unit 110 operating as the search processing unit PG203 or the like held by the management unit PG200 illustrated in FIG. 4.

First, the control unit 110 judges whether a search request is received (S600).

If the control unit 110 analyzes a received message acquired from the communication unit 140 via the communication line 130 and judges that the received message indicates a search request, the control unit 110 judges that a search request is received (YES at S600).

If the control unit 110 analyzes a received message acquired from the request unit PG100 performed by the local terminal apparatus using the technique of inter-process communication or the like and judges that the received message indicates a search request, the control unit 110 may also judge that a search request is received (YES at S600).

If the control unit 110 judges that a search request is received (YES at S600), the control unit 110 performs search processing of the reservation terminal (S601).

That is, the control unit 110 references the reservation terminal list PG210 to acquire the terminal information 2102 corresponding to the contents ID indicated by the received search request (S601).

The terminal information may be a node ID or address information.

If the node ID is used as the terminal information, the address information 1102 may be acquired by referencing the terminal list PG110.

The control unit 110 generates a terminal list, which is a search result, based on the terminal information 2102 acquired in the above processing S601 (S602) and transmits the generated terminal list to the request unit PG100 of the terminal apparatus that has transmitted the search request (S603).

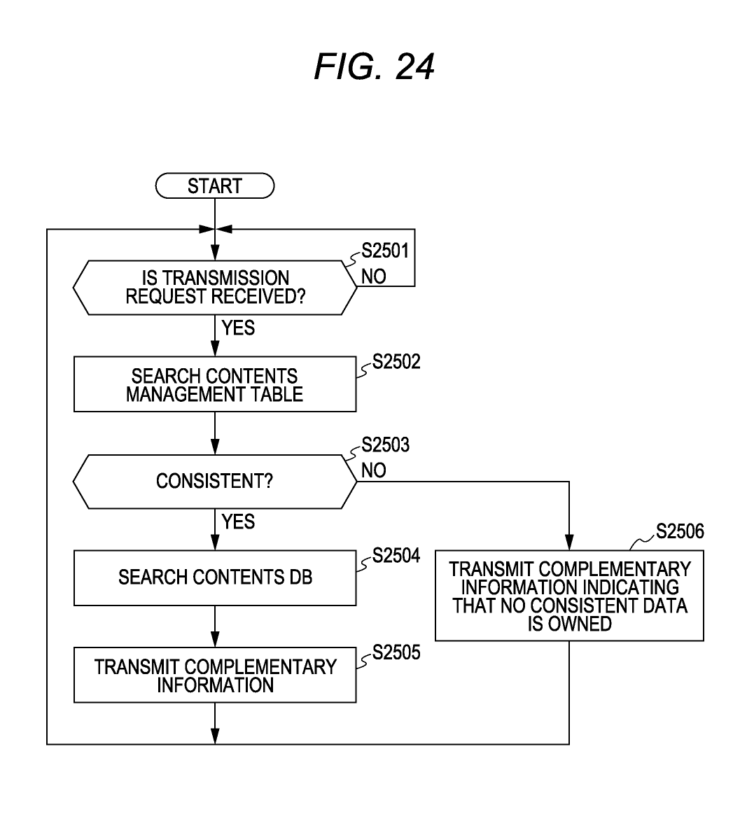

The foregoing is the flow of owning candidate search processing in the management unit PG200 performed by the terminal apparatus 100 according to the present embodiment.

[10. Complementary information transmission processing in the management unit PG200] Next, a procedure for complementary information transmission processing performed by the terminal apparatus 100 that receives an acquisition request transmitted in the above processing S409 will be described using FIG. 24.

FIG. 24 illustrates the flow of complementary information transmission processing in the management unit PG200 performed by the terminal apparatus 100.

The processing procedure illustrated in FIG. 24 is performed by the control unit 110 operating as the complementary information transmission unit PG204 or the like held by the management unit PG200 illustrated in FIG. 4.

First, the control unit 110 judges whether a transmission request of complementary information is received (S2501).

If the control unit 110 analyzes a received message acquired from the communication unit 140 via the communication line 130 and judges that the received message indicates a transmission request of the complementary information, the control unit 110 judges that a transmission request is received (YES at S2501).

If the control unit 110 analyzes a received message acquired from the request unit PG100 performed by the local terminal apparatus using the technique of inter-process communication or the like, and judges that the received message indicates a transmission request of the complementary information, the control unit 110 may also judge that a transmission request of the complementary information is received (YES at S2501).

If the control unit 110 judges that a transmission request is received (YES at S2501), the control unit 110 performs search processing of the contents management table PG112 (S2502).

That is, the control unit 110 acquires contents management information corresponding to the contents ID and divided contents ID indicated in the received transmission request from the contents management table PG112 (S2502).

The control unit 110 references the state information 1123 included in the acquired contents management information to judge whether a value indicating consistency is set (S2503).

If the control unit 110 judges that a value indicating consistency is set to the state information 1123 (YES at S2503), the control unit 110 performs search processing of the contents DB PG115 (S2504).

That is, the control unit 110 acquires contents data corresponding to the contents ID and divided contents ID indicated in the transmission request received in the above processing S2501 from the contents DB PG115 (S2504).

The control unit 110 generates complementary information having the acquired contents data and transmits the generated complementary information to the terminal apparatus that has transmitted the transmission request (S2505).

On the other hand, if the control unit 110 judges in the above processing S2503 that no value indicating consistency is set to the state information 1123 (NO at S2503), the control unit 110 transmits complementary information indicating that no consistent contents data is owned (S2506).

That is, the control unit 110 transmits incomplete complementary information having no contents data corresponding to the contents ID and divided contents ID indicated in the transmission request received in the above processing S2501.

The foregoing is the flow of complementary information transmission processing in the management unit PG200 performed by the terminal apparatus 100.

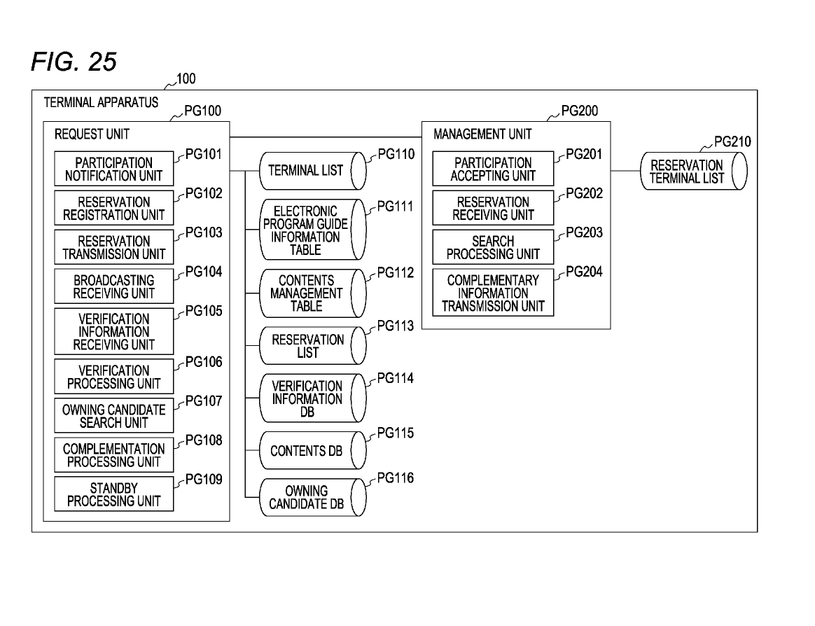

### Second Embodiment

[1. Configuration of a program executed by the terminal apparatus according to the second embodiment] FIG. 25 illustrates the configuration of a program executed by the terminal apparatus according to the present embodiment.

The same reference numerals are attached to the same components of the program illustrated in FIG. 25 as those of the program indicated in the above first embodiment (see FIG. 4).

The configuration of the program illustrated in FIG. 25 is different from that of the program executed by the terminal apparatus according to the first embodiment illustrated in FIG. 4 in that, for example, a standby processing unit PG109 is added.

The standby processing unit PG109 added to the present embodiment causes the control unit 110 to operate as a component to put processing to transmit a request to another terminal apparatus on standby until an arbitrary time passes when contents acquired from the delivery apparatus 200 are defective.

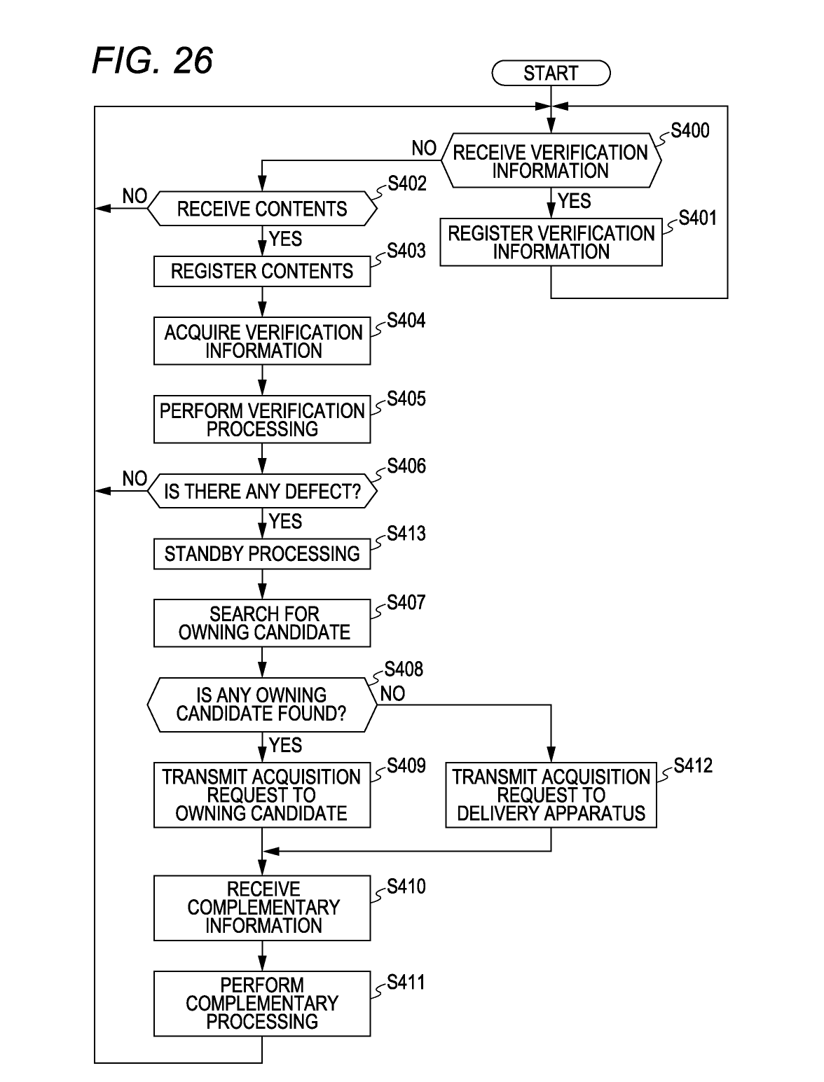

Other components are the same as those in the above first embodiment and thus, a description thereof is omitted.

[2. Recording processing in the request unit PG100 according to the second embodiment] FIG. 26 illustrates the flow of recording processing in the request unit PG100 performed by a terminal apparatus according to the second embodiment.

The processing procedure illustrated in FIG. 26 is performed by the control unit 110 operating as a component according to the broadcasting receiving unit PG104, the verification information receiving unit PG105, the verification processing unit PG106, the owning candidate search unit PG107, the complementary processing unit PG108, the standby processing unit PG109, or the like held by the request unit PG100 illustrated in FIG. 25.

The same reference numerals are attached to processing procedures in the flow of processing illustrated in FIG. 26 of the same content as that of recording processing according to the first embodiment illustrated in FIG. 8.

The processing procedure illustrated in FIG. 26 is different from that illustrated in FIG. 8 in that processing S413 is added.

Thus, for simplification of description, the description of processing procedures of the same content is partially omitted.

Like the processing S405 in the first embodiment, the control unit 110 of the terminal apparatus 100 according to the present embodiment performs verification processing of consistency of contents data included in contents information using the verification data 1143 included in the verification information acquired in the processing S404 (S405).

If, as a result of performing the above processing S405, the control unit 110 judges that the contents data is defective (YES at S406), the control unit 110 performs standby processing, which is specific to the present embodiment (S413).

In the above standby processing (S413), the standby time may be set based on a random number or a logical distance between the local terminal apparatus and a terminal apparatus selected as the management node.

Here, as the logical distance, a difference between the node ID of the local terminal apparatus and that of the terminal apparatus selected as the management node may be used.

The control unit 110 divides a numeric value obtained based on the above random number or logical distance by the preset maximum wait time and sets the remainder thereof as the standby time.

Then, the control unit 110 measures the passage of time, and performs the search processing for retrieving a candidate that owns the contents after the standby time passes (S407).

Processing thereafter is the same as that in the first embodiment and thus, a description thereof is omitted.

Timing of performing the above standby processing may be changed where appropriate in a stage before a search request is transmitted to the management node in the above search processing (S407) of an owning candidate.

The foregoing is the flow of recording processing in the management unit PG200 performed by the terminal apparatus 100 according to the second embodiment.

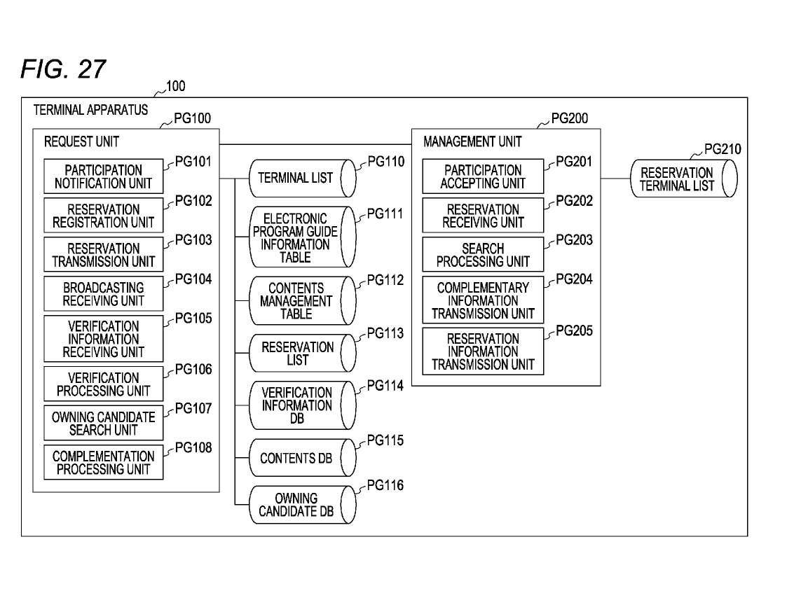

### Third Embodiment

[1. Configuration of a program executed by the terminal apparatus according to the third embodiment] FIG. 27 illustrates the configuration of a program executed by the terminal apparatus according to the present embodiment.

The same reference numerals are attached to the same components of the program illustrated in FIG. 27 as those of the program indicated in the above first embodiment (see FIG. 4).

The configuration of the program illustrated in FIG. 27 is different from that of the program executed by the terminal apparatus according to the first embodiment illustrated in FIG. 4 in that, for example, a reservation information transmission unit PG205 is added.

The reservation information transmission unit PG205 added to the present embodiment causes the control unit 110 to operate as a component to transmit reservation information received by the control unit 110 operating as a component according to the reservation receiving unit PG202 to a terminal apparatus registered in the reservation terminal list PG210.

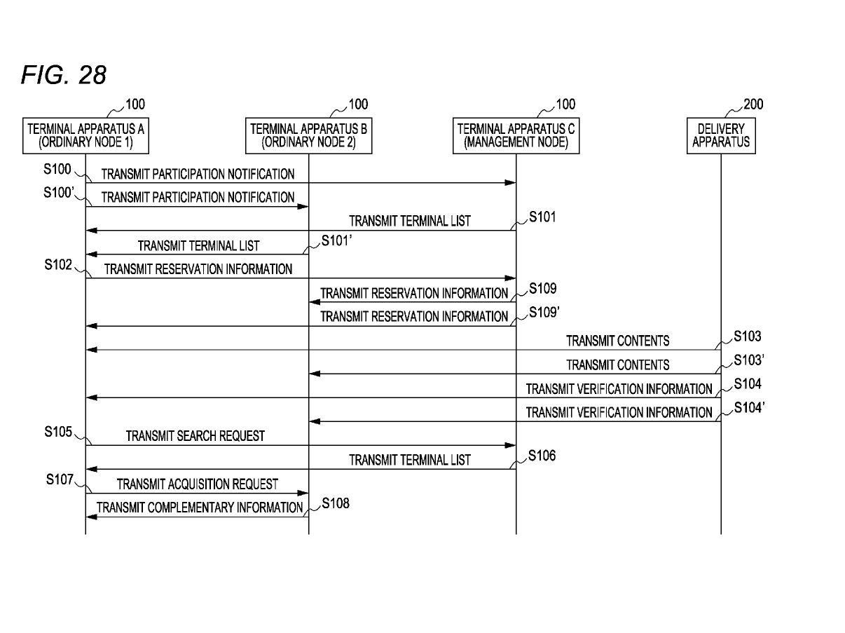

Other components are the same as those in the first embodiment and thus, a description thereof is omitted.

[2. Diagram illustrating the flow of processing of a system according to the third embodiment] FIG. 28 is a diagram illustrating the flow of processing of a system according to the present embodiment.

In the example illustrated in FIG. 28, the same reference numerals are attached to the same processing as the flow of processing in the system illustrated in the above first embodiment (see FIG. 5).

The flow of processing illustrated in FIG. 28 is different from that of processing illustrated in FIG. 5 in that transmission processing S109 of reservation information is added.

Thus, for simplification of description, the description of processing procedures of the same content is partially omitted.

Like FIG. 5, the example illustrated in FIG. 28 illustrates the flow of processing in which the terminal apparatus A (100) participating in a system according to the present embodiment and the terminal apparatus A (100) receives contents from the system according to the present embodiment.

First, the terminal apparatus A participates in a P2P system, according to a procedure similar to that in the first embodiment (S100 to S101).

When an instruction to make a reservation to receive delivery of contents by an input operation of the operator is received, the terminal apparatus A stores reservation details in the storage unit 120 and transmits reservation information indicating the reservation details to the management node identified based on the reserved details (S102).

The terminal apparatus C searches for the terminal apparatus registered in the reservation terminal list by associating the same contents ID with the contents ID indicated in the reservation information received from the terminal apparatus A.

That is, the control unit 110 operating as a component according to the reservation receiving unit PG202 held by the management unit PG200 illustrated in FIG. 27 searches the reservation terminal list PG210 held in the storage unit 120 for the corresponding reservation information using the contents ID indicated in the reservation information received via the communication unit 140.

Here, the terminal apparatus B is registered in the reservation terminal list of the terminal apparatus C by associating the same contents ID with the contents ID indicated in the reservation information received from the terminal apparatus A.

The terminal apparatus C transmits the reservation information received from the terminal apparatus A to the terminal apparatus B registered in the reservation terminal list (S109).

That is, the control unit 110 operating as a component according to the reservation information transmission unit PG205 held by the management unit PG200 illustrated in FIG. 27 transmits the reservation information via the communication unit 140.

The terminal apparatus B updates the reservation terminal list stored in the storage unit 120 based on the reservation information received from the terminal apparatus C.

That is, the control unit 110 operating as a component according to the reservation receiving unit PG202 held by the management unit PG200 illustrated in FIG. 27 registers the reservation information received via the communication unit 140 in the reservation terminal list PG210 held in the storage unit 120.

The terminal apparatus C transmits the reservation information registered in the reservation terminal list to the terminal apparatus A that has transmitted the reservation information.

That is, the control unit 110 operating as a component according to the reservation information transmission unit PG205 held by the management unit PG200 illustrated in FIG. 27 transmits the reservation information via the communication unit 140.

The terminal apparatus A updates the reservation terminal list stored in the storage unit 120 based on the reservation information received from the terminal apparatus C.

That is, the control unit 110 operating as a component according to the reservation receiving unit PG202 held by the management unit PG200 illustrated in FIG. 27 registers the reservation information received via the communication unit 140 in the reservation terminal list PG210 held in the storage unit 120.

The terminal apparatus C updates the reservation terminal list stored in the storage unit 120 based on the reservation information received from the terminal apparatus A.

FIG. 15 illustrates an example of the reservation terminal list held by the terminal apparatus C.

The example illustrated in FIG. 15 indicates that information to identify the contents A-4 is registered as the contents ID 1501, and an address 1 of the terminal apparatus A and an address 2 of the terminal apparatus B are registered as information indicating addresses of terminal apparatuses that have transmitted reservation information for the contents A-4.

Subsequent processing is the same as the flow of processing of the system according to the first embodiment and thus, a description thereof is omitted.

With the above processing, reservation information transmitted to the terminal apparatus selected as the management node may be shared by each terminal apparatus.

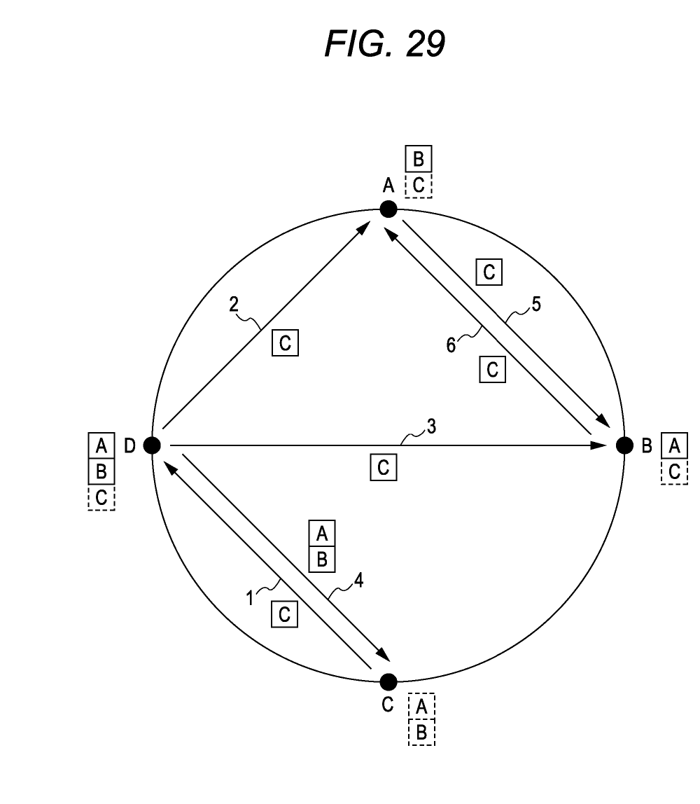

FIG. 29 conceptually illustrates the flow of reservation information shared in a system according to the present embodiment.

In FIG. 29, black dots A, B, C, and D represent terminal apparatuses and are called terminal apparatuses A, B, C, and D respectively.

FIG. 29 illustrates that the terminal apparatus A has information about the terminal apparatus B registered in the reservation terminal list.

FIG. 29 illustrates that the terminal apparatus B has information about the terminal apparatus A registered in the reservation terminal list.

FIG. 29 illustrates that the terminal apparatus D has information about the terminal apparatus A and the terminal apparatus B registered in the reservation terminal list.

FIG. 29 illustrates that the terminal apparatus C transmits (1) reservation information generated after an operation from a user being accepted to the terminal apparatus D selected as the management node.

FIG. 29 illustrates that the terminal apparatus D transmits (2, 3) the reservation information received from the terminal apparatus C to the terminal apparatuses A and B registered in the reservation terminal list.

FIG. 29 illustrates that the terminal apparatus D transmits (4) reservation information generated based on terminal information about the terminal apparatuses A and B registered in the reservation terminal list to the terminal apparatus C, which is the transmission source of the reservation information.

FIG. 29 illustrates that the terminal apparatus C registers the reservation information received from the terminal apparatus D in the reservation terminal list.

FIG. 29 illustrates that the terminal apparatus D registers the reservation information received from the terminal apparatus C in the reservation terminal list.

FIG. 29 illustrates that the terminal apparatus A transmits (5) the reservation information about the terminal apparatus C received from the terminal apparatus D to the terminal apparatus B registered in the reservation terminal list.

FIG. 29 illustrates that the terminal apparatus A registers the reservation information about the terminal apparatus C received from the terminal apparatus D in the reservation terminal list.

FIG. 29 illustrates that the terminal apparatus B transmits (6) the reservation information about the terminal apparatus C received from the terminal apparatus D to the terminal apparatus A registered in the reservation terminal list.

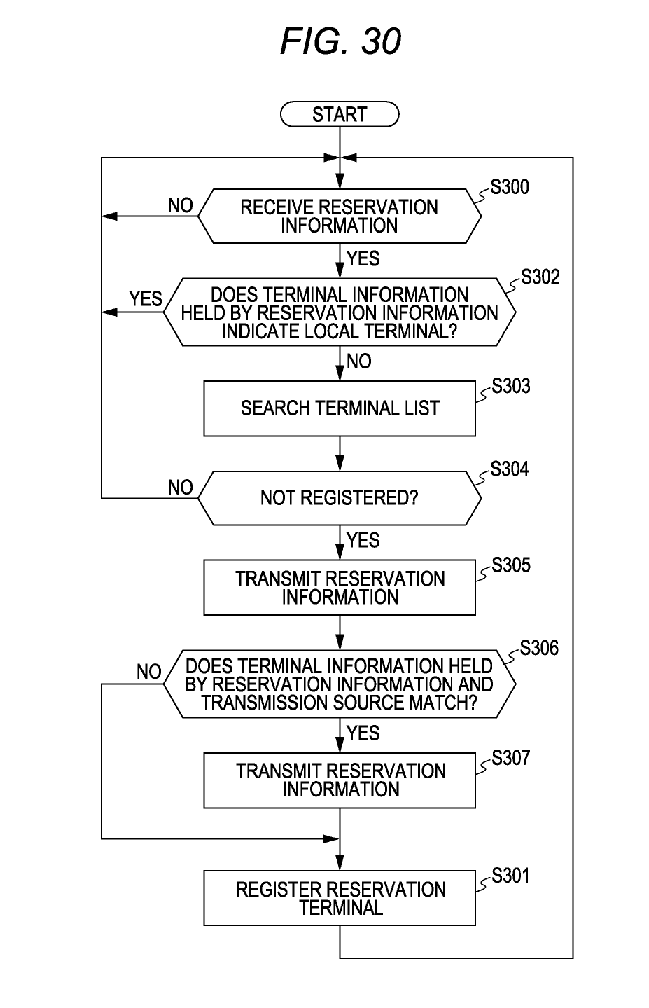

FIG. 29 illustrates that the terminal apparatus B registers the reservation information about the terminal apparatus C received from the terminal apparatus D in the reservation terminal list.

[3. Flow of reservation processing in the management unit PG200 in the third embodiment] FIG. 30 illustrates a procedure for reservation processing in the management unit PG200 performed by the terminal apparatus according to the third embodiment.

In the example illustrated in FIG. 30, the same reference numerals are attached to the same processing as the flow of reservation processing in the management unit PG200 indicated in the above first embodiment (see FIG. 7).

The flow of processing illustrated in FIG. 30 is different from that of processing illustrated in FIG. 7 in that, for example, transmission processing S302 to S307 of reservation information is added.

Thus, for simplification of description, the description of processing procedures of the same content is partially omitted.

First, the control unit 110 of the terminal apparatus judges whether reception of reservation information is detected (S300).

If the control unit 110 analyzes a received message acquired from the communication unit 140 via the communication line 130 and judges that the received message indicates reservation information, the control unit 110 judges that reception of the reservation information is detected (YES at S300).

If the control unit 110 detects reception of reservation information (YES at S300), the control unit 110 references terminal information included in the reservation information acquired from the communication unit 140 to judge whether the terminal information indicates the local terminal apparatus (S302).

If, for example, address information indicated in the terminal information is the same as that allocated to the local terminal apparatus, the control unit 110 judges that the terminal information indicates the local terminal apparatus (YES at S302).

If, for example, the node ID indicated in the terminal information is the same as that allocated to the local terminal apparatus, the control unit 110 also judges that the terminal information indicates the local terminal apparatus (YES at S302).

If the control unit 110 judges that the terminal information included in the received reservation information does not indicate the local terminal apparatus (NO at S302), the control unit 110 searches the reservation terminal list PG210 based on the received reservation information (S303).

That is, the control unit 110 searches for the terminal apparatus registered in the reservation terminal list PG210 corresponding to the same contents ID as the contents ID indicated in the received reservation information (S303).

On the other hand, if the control unit 110 judges in the above processing S302 that the terminal information included in the received reservation information indicates the local terminal apparatus (YES at S302), the control unit 110 performs the processing S300 again.

The control unit 110 references terminal information acquired from the reservation terminal list by the search processing in the above processing S303 to judge whether terminal information included in the reservation information received in the above processing S300 is registered in the reservation terminal list PG210 (S304).

For example, if the control unit 110 compares terminal information included in the reservation information received in the above processing S300 with terminal information acquired by the search processing in the above processing S303 and terminal information having the same value is present, the control unit 110 judges that the terminal information included in the reservation information received in the above processing S300 is registered in the reservation terminal list PG210.

If the control unit 110 compares terminal information included in the reservation information received in the above processing S300 with terminal information acquired by the search processing in the above processing S303 and there is no terminal information having the same value, the control unit 110 judges that the terminal information included in the reservation information received in the above processing S300 is not registered in the reservation terminal list PG210.

If the control unit 110 judges that terminal information is not registered in the above processing S304 (YES at S304), the control unit 110 transmits, via the communication unit 140, the reservation information received in the above processing S300 to the terminal apparatus indicated in the terminal information acquired by the search processing in the above processing S303 (S305).

The reservation terminal list includes the contents ID and terminal information.

The terminal information 2102 may be a node ID or address information.

The control unit 110 judges whether the terminal apparatus indicated by the terminal information included in the reservation information received in the above processing S300 matches the terminal apparatus that is the transmission source of the reservation information (S306).

The control unit 110 may determine the transmission source terminal apparatus by analyzing a received message acquired from the communication unit 140 in the above processing S300.

For example, the transmission source terminal apparatus may be determined by referencing the transmission source IP address (Source Address) indicated in the IP (Internet Protocol) header included in the received message.

If the control unit 110 judges that the terminal apparatus indicated by the terminal information included in the reservation information received in the above processing S300 matches the terminal apparatus that is the transmission source of the reservation information (YES at S306), the control unit 110 transmits reservation information having the terminal information and contents ID acquired by the search processing in the above processing S303 to the terminal apparatus which is the transmission source of the received reservation information (S307).

The control unit 110 registers reservation terminal information having the contents ID 2101 and the terminal information 2102 in the reservation terminal list PG210 based on the contents ID and terminal information indicated in the reservation information received in the above processing S300 (S301).

Here, the terminal information 2102 may be a node ID or address information.

On the other hand, if the control unit 110 judges in the above processing S306 that the terminal apparatus indicated by the terminal information included in the reservation information does not match the terminal apparatus that is the transmission source of the reservation information (NO at S306), the control unit 110 performs registration processing in the above processing S301 without performing the above processing S307.

The foregoing is the flow of reservation processing in the management unit PG200 performed by the terminal apparatus 100 according to the present embodiment.

[4. Owning candidate search processing in the request unit 100 in the third embodiment]

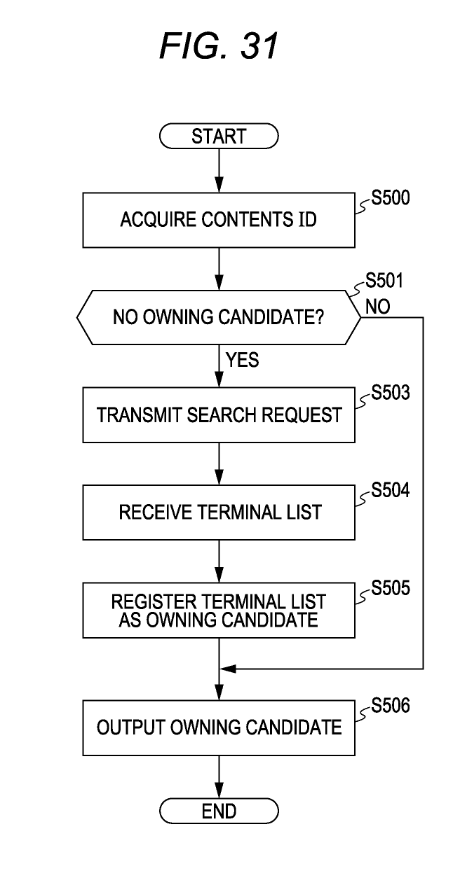

FIG. 31 illustrates a procedure for owning candidate search processing in the request unit PG100 performed by the terminal apparatus according to the third embodiment.

In the example illustrated in FIG. 31, the same reference numerals are attached to the same processing as the flow of owning candidate search processing in the request unit PG100 indicated in the above first embodiment (see FIG. 9).

The flow of processing illustrated in FIG. 31 is different from that of processing illustrated in FIG. 9 in that, for example, the selection processing (S502) of the management node is deleted.

Thus, for simplification of description, the description of processing procedures of the same content is partially omitted.

First, the control unit 110 starts owning candidate search processing by performing verification processing on received contents (S405 in FIG. 8) according to a processing procedure similar to that for the flow of recording processing in the request unit PG100 indicated in the first embodiment (see FIG. 8) and performing search processing of owning candidates by specifying the contents ID of contents judged to be defective (S407 in FIG. 8).

That is, the control unit 110 starts owning candidate search processing after the contents ID are specified (S500).

Here, the contents ID is a contents ID corresponding to contents data judged to be defective by the verification processing performed in the above processing S405.

The control unit 110 judges whether information about an owning candidate is present (S501).

If, for example, the control unit 110 has acquired information about an owning candidate from the management unit PG200 performed by the local terminal apparatus, the control unit 110 judges that information about an owning candidate is present (NO at S501).

If the control unit 110 judges in the above processing S501 that information about an owning candidate is present (NO at S501), the control unit 110 outputs information about owning candidates already held as a search result (S506).

On the other hand, if the control unit 110 judges in the above processing S501 that information about an owning candidate is not present (YES at S501), the control unit 110 transmits a search request to the management unit PG200 performed by the local terminal apparatus using a technique such as inter-process communication (S503).

The control unit 110 receives a terminal list as a search result from the transmission destination of the search request (S504) and registers the received terminal list in the owning candidate DB PG116 (S505).

The terminal list received in the above processing S504 includes the contents ID and terminal information.

The terminal information may be a node ID or address information.

If the node ID is used as the terminal information, the address information 1102 may be acquired by referencing the terminal list PG110.

The control unit 110 outputs the terminal list received in the above processing S504 as an owning candidate (S506).

The foregoing is the flow of owning candidate search processing in the request unit PG100 performed by the terminal apparatus 100 according to the present embodiment.

Owning candidate search processing in the management unit PG200 performed by the terminal apparatus according to the present embodiment is the same as that in the first embodiment and thus, a description thereof is omitted.

### Fourth Embodiment

[1. Overview of the fourth embodiment] The present embodiment has a configuration similar to that of the third embodiment to which standby processing similar to that in the second embodiment is added.

However, the standby processing in the present embodiment puts execution of transmission processing of an acquisition request to request transmission of complementary information on standby until an arbitrary time passes.

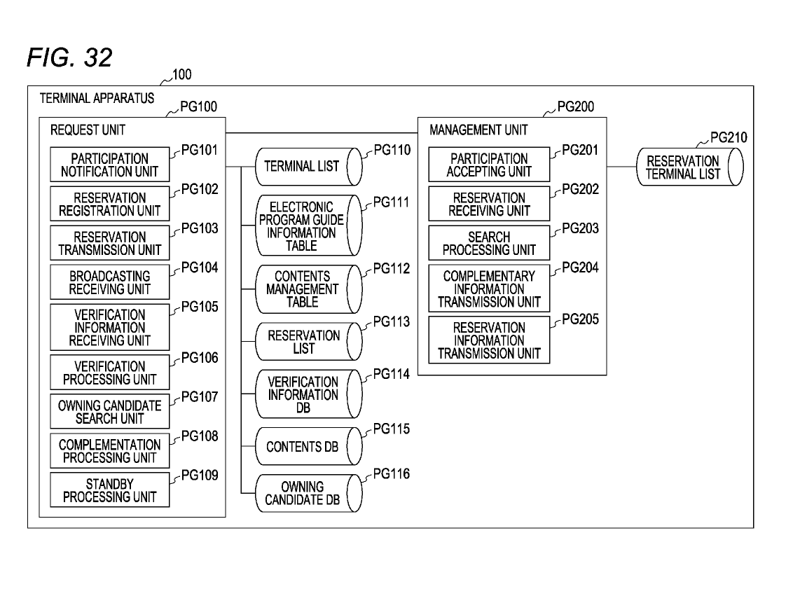

In a description that follows, the description of content similar to that in the third embodiment is partially omitted.

[2. Configuration of a program executed by the terminal apparatus according to the fourth embodiment] FIG. 32 illustrates the configuration of a program executed by the terminal apparatus according to the present embodiment.

The same reference numerals are attached to the same components of the program illustrated in FIG. 32 as those of the program indicated in the above third embodiment (see FIG. 27).

The configuration of the program illustrated in FIG. 32 is different from that of the program according to the third embodiment illustrated in FIG. 27 in that, for example, the standby processing unit PG109 is added.

The standby processing unit PG109 added to the present embodiment is a software component that causes the control unit 110 to operate as a component that puts processing to transmit a request to other terminal apparatuses on standby until an arbitrary time passes when contents acquired from the delivery apparatus 200 are defective.

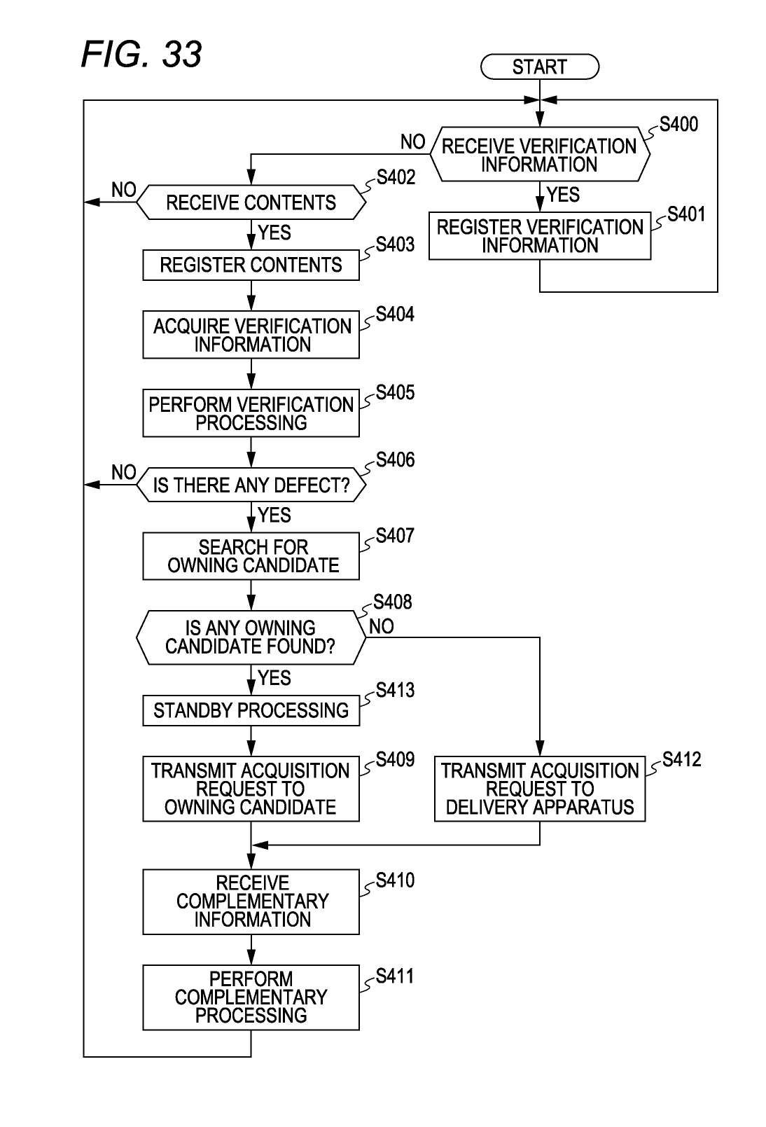

Other components are the same as those in the third embodiment and thus, a description thereof is omitted.

[3. Recording processing in the request unit PG100 according to the fourth embodiment] FIG. 33 illustrates the flow of recording processing in the request unit PG100 performed by a terminal apparatus according to the fourth embodiment.

The processing procedure illustrated in FIG. 33 is performed by the control unit 110 operating as a component according to the broadcasting receiving unit PG104, the verification information receiving unit PG105, the verification processing unit PG106, the owning candidate search unit PG107, the complementary processing unit PG108, the standby processing unit PG109, or the like held by the request unit PG100 illustrated in FIG. 32.

First, the control unit 110 of the terminal apparatus judges whether verification information is received (S400).

If the control unit 110 analyzes a received message acquired from the communication unit 140 via the communication line 130 and judges that the received message indicates verification information, the control unit 110 judges that verification information is received (YES at S400).

If the control unit 110 judges that verification information is received (YES at S400), the control unit 110 registers the received verification information in the verification information DB PG114.

As illustrated in FIG. 20, the verification information includes the contents ID 1141, the divided contents ID 1142, and verification data 1143.

As the verification data, for example, a hash value obtained by hashing contents data divided into certain time units may be used.

If the control unit 110 judges in the above processing S400 that no verification information is received (NO at S400), the control unit 110 judges whether or not contents are received (S402).

If the control unit 110 analyzes a received message acquired from the communication unit 140 via the communication line 130 and judges that the received message indicates contents information, the control unit 110 judges that contents are received (YES at S402).

If the control unit 110 judges that contents information is received (YES at S402), the control unit 110 registers the received contents information in the contents DB PG115 and contents management information indicating a state of the received contents information in the contents management table PG112 (S403).

As illustrated in FIG. 21, the contents information includes the contents ID 1151, the divided contents ID 1152, and the contents data 1153.

The contents data 1153 is contents data obtained by dividing contents identified by the contents ID 1151 into certain time units or the like.

As illustrated in FIG. 18, the contents management information includes the contents ID 1121, the divided contents ID 1122, and the state information 1123.

The state information 1123 indicates a result of verification processing performed on contents data included in the contents information.

The state information 1123 has, for example, a value indicating “not verified” before verification processing being performed stored therein.

If, as a result of performing verification processing, consistency with the verification information is found, a value indicating “consistent” is stored, and if no consistency with the verification information is found, a value indicating “not consistent” is stored.

Contents information received by the radio receiver 500 may not include the divided contents ID.

In this case, contents data included in contents information received by the radio receiver 500 may be reconfigured into units for verification processing with the sequence number indicating the reconfigured order attached by the terminal apparatus 100.

That is, in this example, the above sequence number may be used as the divided contents ID included in contents information and verification information.

Next, the control unit 110 acquires verification information corresponding to the contents ID and divided contents ID included in the contents information registered in the contents DB in the above processing S403 from the verification information DB (S404).

The control unit 110 uses the verification data 1143 included in the acquired verification information to perform verification processing of consistency of contents data included in the contents information.

The control unit 110 compares, for example, a hash value generated from the contents data using the same algorithm as that used for generating verification data with the verification data and if both values match, the control unit 110 may judge that the contents data is consistent (No at S406).

That is, if the control unit 110 judges that contents data is not defective (NO at S406), the control unit 110 performs processing in the above processing S400 and thereafter.

On the other hand, if, as a result of performing the above processing S405, the control unit 110 judges that contents data is defective (YES at S406), the control unit 110 searches for an owning candidate indicating a terminal apparatus that may have data to complement defects (S407).

An example of search processing in the processing S407 will be described later.

The control unit 110 judges, as a result of performing search processing, whether an owning candidate is obtained (S408).

If, as a result of performing the above search processing, the control unit 110 judges that an owning candidate is obtained (YES at S408), the control unit 110 performs standby processing, which is specific to the present embodiment (S413).

In the above standby processing (S413), the standby time may be set based on a random number or the number of terminal apparatuses indicated by owning candidates acquired by the owning candidate search processing in the above processing S407.

The control unit 110 may decide the value of the maximum standby time based on, for example, the number of terminal apparatuses indicated by owning candidates acquired by the owning candidate search processing in the above processing S407 and set the standby time randomly in the range of the decided value and 0.

Accordingly, the maximum standby time that may be set may be adjusted in accordance with the number of owning candidates.

That is, if the number of owning candidates increases, there is a possibility that the standby time performed in the above processing S413 is set longer compared with a case of a smaller number of owning candidates.

As a result, in the present embodiment, concentration of acquisition requests transmitted from terminal apparatuses in a short time may effectively be avoided.

If, on the other hand, the number of owning candidates decreases, the maximum standby time performed in the above processing S413 is set shorter compared to a case of a larger number of owning candidates.

This is because the possibility of acquisition requests transmitted from terminal apparatuses being concentrated in a short time decreases with a decreasing number of owning candidates.

That is, in this case, complementary processing may be completed earlier by setting the range of time in which timing to transmit an acquisition request is distributed shorter compared to a case of a larger number of owning candidates.

After the standby time passes, the control unit 110 transmits an acquisition request to request transmission of complementary information to the terminal apparatus indicated by an owning candidate acquired by the above search processing (S409).

Here, the acquisition request transmitted to the terminal apparatus indicated by an owning candidate includes the contents ID and divided contents ID corresponding to contents data judged to be defective in the above verification processing.

Data organized in list form indicating a plurality of terminal apparatuses may be used as owning candidates acquired in the above search processing (S407).

In this case, the control unit 110 may select terminal apparatuses indicated in the owning candidate list in any order to sequentially transmit an acquisition request to these terminal apparatuses or multicasting may be used (S409).

On the other hand, if the control unit 110 judges in the above processing S408 that acquisition of owning candidates failed (NO at S408), the control unit 110 transmits an acquisition request to request transmission of complementary information to the delivery apparatus 200 (S412).

Here, the acquisition request transmitted to the delivery apparatus 200 includes the contents ID and divided contents ID corresponding to contents data judged to be defective in the above verification processing.

The control unit 110 receives complementary information from the transmission destination of the acquisition request (S410) and performs complementary processing using the received complementary information (S411).

Here, the complementary information received from the transmission destination of the acquisition request includes the contents ID, divided contents ID, and contents data.

That is, in the above complementary processing, the control unit 110 searches the contents DB PG115 for contents information corresponding to the contents ID and divided contents ID included in the received complementary information.

Then, the control unit 110 updates contents data included in the searched contents information by using contents data included in the received complementary information.

If the transmission destination of the acquisition request does not own consistent contents data, the control unit 110 receives incomplete complementary information in the above processing S410.

In this case, the control unit 110 discards the complementary information without performing the above processing S411 and may perform reception processing of complementary information from the terminal apparatus of another owning candidate or from the delivery apparatus.

The foregoing is the flow of recording processing in the request unit PG100 performed by the terminal apparatus 100.

In the above example, recording processing using the terminal apparatus 100 is described and the above complementary processing may be performed when delivered contents are reproduced.

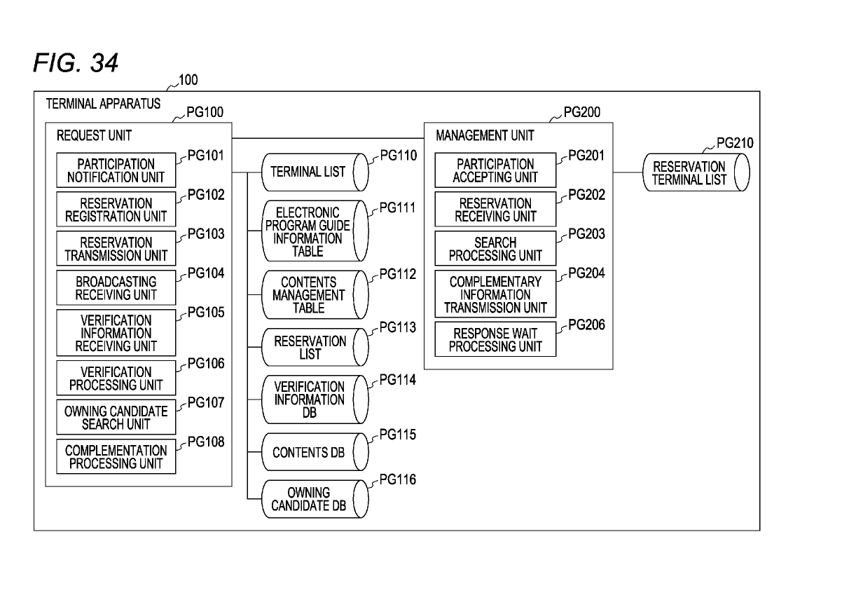

### Fifth Embodiment

[1. Configuration of a program executed by the terminal apparatus according to the fifth embodiment] FIG. 34 illustrates the configuration of a program executed by the terminal apparatus according to the present embodiment.

The same reference numerals are attached to the same components of the program illustrated in FIG. 34 as those of the program indicated in the above first embodiment (see FIG. 4).

The configuration of the program illustrated in FIG. 34 is different from that of the program according to the first embodiment illustrated in FIG. 4 in that, for example, a response wait processing unit PG206 is added.

The response wait processing unit PG206 added to the present embodiment is a software component that causes the control unit 110 to operate as a component that puts transmission processing of a terminal list as a search result on standby until an arbitrary time passes when a search request of an owning candidate is received.

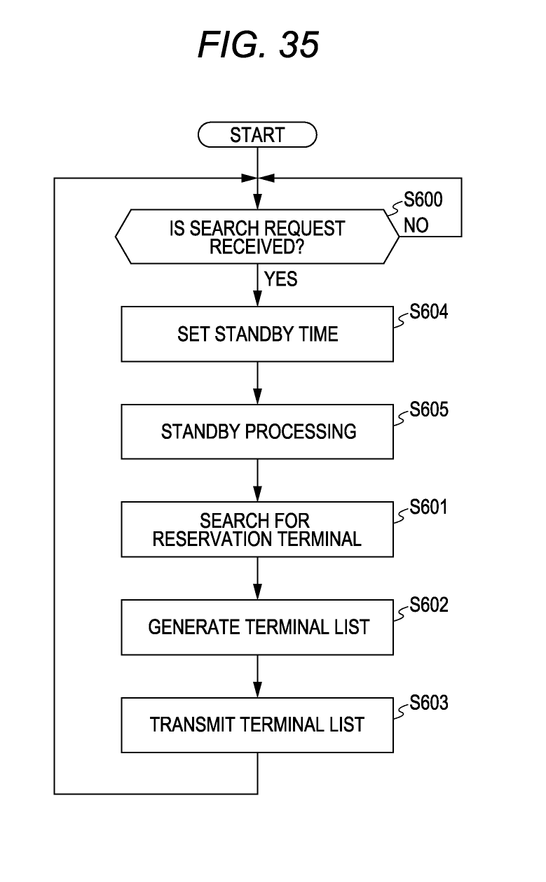

Other components are the same as those in the above embodiments and thus, a description thereof is omitted.

[2. Owning candidate search processing in the management unit performed by the terminal apparatus according to the fifth embodiment] In the flow of processing illustrated in FIG. 35, the same reference numerals are attached to processing procedures of the same content as that of owning candidate search processing in the first embodiment illustrated in FIG. 10.

The processing procedure illustrated in FIG. 35 is different from that illustrated in FIG. 10 in that, for example, processing S604 and processing S605 are added.

Thus, for simplification of description, the description of processing procedures of the same content is partially omitted.

First, the control unit 110 of the terminal apparatus 100 judges whether a search request is received (S600). If the control unit 110 judges that a search request is received (YES at S600), the control unit 110 sets a standby time in which execution of transmission processing of a terminal list is put on standby in the processing S603 (S604).

In the processing S604, the control unit 110 may set the standby time generated based on a random number.

In the processing S604, the control unit 110 may also set a standby time generated based on the number of search requests from other terminal apparatuses put on standby.

For example, the count value is incremented each time a search request is received in the processing S600, a standby time generated based on the count value is set in the processing S604, and the count value is decremented each time a terminal list is transmitted in the processing S603.

For example, the standby time may be set longer for a larger count value and shorter for a smaller count value in the processing S604.

Next, the control unit 110 puts execution of search processing (S605) of owning candidates on standby until the set standby time passes.

In the processing S605, the control unit 110 may transmit a signal indicating that the search processing (S605) is put on standby in a certain timing to terminal apparatuses until the standby time passes.

Before starting the processing S605, the control unit 110 may transmit a signal indicating that a search request is received to terminal apparatuses.

After the standby time passes, the control unit 110 performs search processing (S601) of a reservation terminal.

Subsequent processing is the same as that in the first embodiment and thus, a description thereof is omitted.

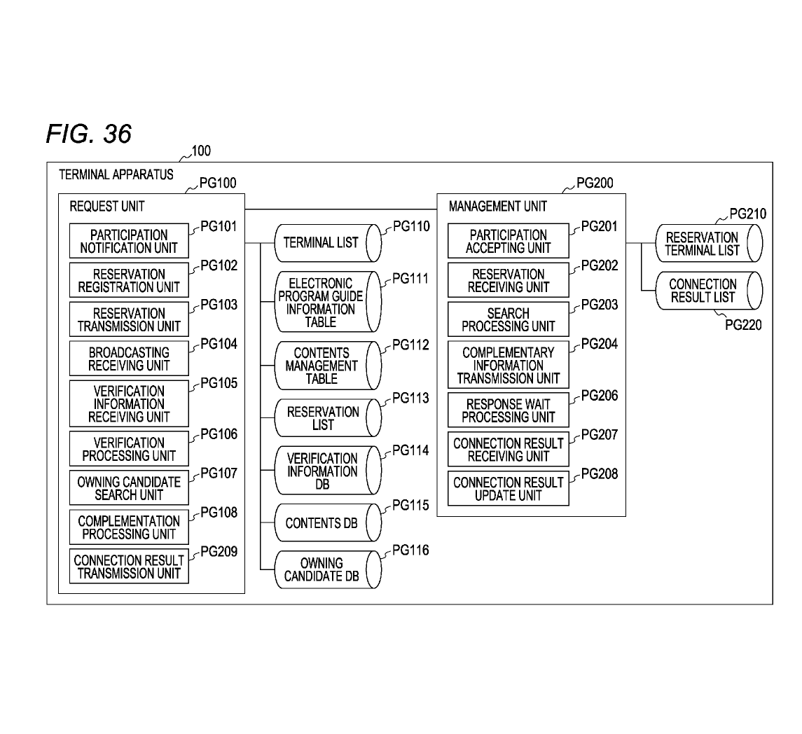

### Sixth Embodiment

[1. Configuration of a program executed by the terminal apparatus according to the sixth embodiment] FIG. 36 illustrates the configuration of a program executed by the terminal apparatus according to the present embodiment.

The same reference numerals are attached to the same components of the program illustrated in FIG. 36 as those of the program indicated in the above fifth embodiment (see FIG. 34).

The configuration of the program illustrated in FIG. 36 is different from that of the program according to the fifth embodiment illustrated in FIG. 34 in that, for example, a connection result transmission unit PG209, a connection result receiving unit PG207, a connection result update unit PG208, and a connection result list PG220 are added.

The connection result transmission unit PG209 is a software component that causes the control unit 110 to operate as a component that transmits connection result information indicating a transmission and/or reception result of complementary information in a process of the complementary processing unit PG108 to the management node using the communication unit 140.

Here, the connection result information includes the contents ID, terminal information, and a connection result.

The contents ID of contents corresponding to complementary information in the process of the complementary processing unit PG108 is set as the contents ID indicated in the connection result information.

Information to identify the terminal apparatus that performs the complementary processing unit PG108 is set as the terminal information indicated in the connection result information.

The connection result indicated in the connection result information indicates a transmission and/or reception result of complementary information in the process of the complementary processing unit PG108.

The connection result receiving unit PG207 causes the control unit 110 to operate as a component that receives connection result information transmitted by a process of the connection result transmission unit PG209 by using the communication unit 140.

The connection result update unit PG208 is a software component that causes the control unit 110 to operate as a component that updates a connection result list PG220 based on connection result information received by a process of the connection result receiving unit PG207.

The response wait processing unit PG206 according to the present embodiment is a software component that causes the control unit 110 to operate as a component that sets the standby time based on the connection result list PG220.

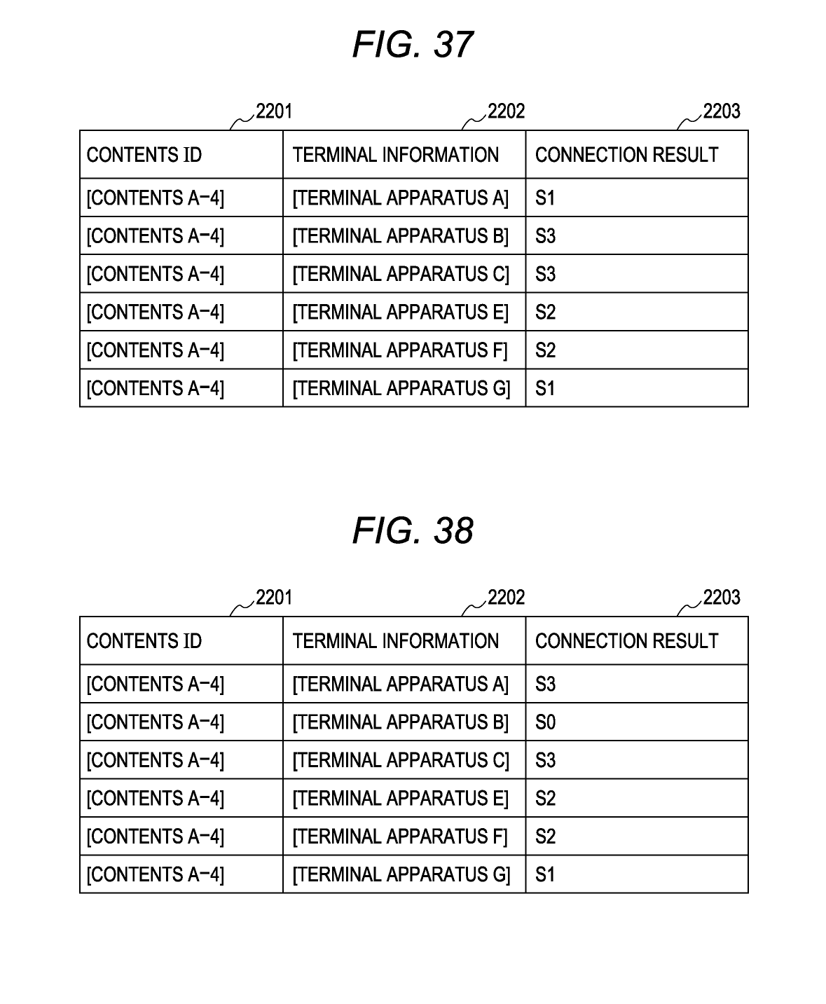

FIG. 37 illustrates the data structure of a connection result list according to the present embodiment.

The connection result list illustrated in FIG. 37 includes a contents ID 2201, terminal information 2202, and a connection result 2203.

The contents ID indicated in connection result information received by the process of the connection result receiving unit PG207 is set as the contents ID 2201 illustrated in FIG. 37.

That is, the contents ID of contents corresponding to complementary information in the process of the complementary processing unit PG108 is set.

The terminal information indicated in connection result information received by the process of the connection result receiving unit PG207 is set as the terminal information 2202 illustrated in FIG. 37.

That is, information to identify the terminal apparatus that has transmitted connection result information is set.

For example, the IP address, node ID, and the like of a terminal apparatus may be used as the terminal information.

The connection result indicated in connection result information received by the process of the connection result receiving unit PG207 is set as the connection result 2203 illustrated in FIG. 37.

In the example illustrated in FIG. 37, the connection results (2203) of the terminal apparatuses A to G are indicated in association with the contents ID (2201) “contents A-4”.

In the example illustrated in FIG. 37, “S1” indicating a state in which no terminal list is transmitted after a search request is accepted is set as a connection result of the terminal apparatuses A and G.

In the example illustrated in FIG. 37, “S2” indicating a state in which reception of complementary information is not completed after the terminal list is transmitted is set as a connection result of the terminal apparatuses E and F.

In the example illustrated in FIG. 37, “S3” indicating a state in which reception of complementary information is completed is set as a connection result of the terminal apparatuses B and C.

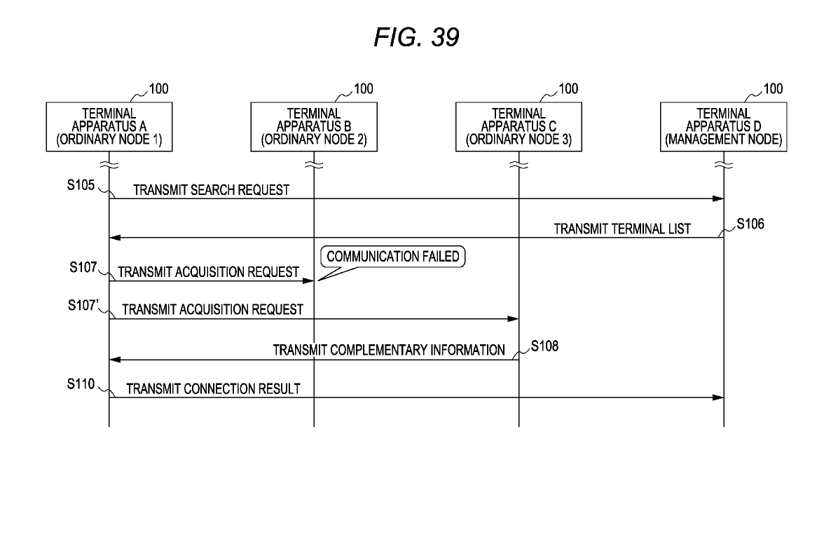

Other components are the same as those in the above embodiments and thus, a description thereof is omitted.

[2. Flow of processing in a system according to the sixth embodiment] FIG. 39 illustrates the flow of processing of a system according to the sixth embodiment.

In the example illustrated in FIG. 39, the same reference numerals are attached to the same processing as the flow of processing in the system indicated in the above first embodiment (see FIG. 5).

The flow of processing illustrated in FIG. 39 is different from that of processing illustrated in FIG. 5 in that, for example, transmission processing S110 of a connection result is added.

Thus, for simplification of description, the description of processing procedures of the same content is partially omitted.

Like FIG. 5, the example illustrated in FIG. 39 illustrates the flow of processing that the terminal apparatus A (100) receives contents from a system according to the present embodiment.

However, among four terminal apparatuses of the terminal apparatus A to the terminal apparatus D, the terminal apparatus D functions as the management node and the terminal apparatus A to the terminal apparatus C function as ordinary nodes.

First, like the first embodiment, the terminal apparatus A transmits a search request to obtain the location of a terminal apparatus owning complementary information of an applicable location to the terminal apparatus D operating as the management node.

If the search request is received, the terminal apparatus D updates the connection result list based on details of the received search request.

That is, the terminal apparatus D sets “S1” to the connection result (2203) registered in association with the contents ID indicated in the received search request and the terminal apparatus that has transmitted the search request.

Here, “S1” indicates a state in which no terminal list is transmitted after a search request is accepted.

After the standby time set based on the connection result list (PG220) passes, the terminal apparatus D transmits a terminal list generated based on reservation terminal information acquired in a similar way as in the first embodiment to the terminal apparatus A that has transmitted the search request (S106).

At this point, the terminal apparatus D updates the connection result list PG220.

That is, the terminal apparatus D sets “S2” to the connection result 2203 registered by associating with the contents ID indicated in the received search request and the terminal apparatus that has transmitted the search request.

Here, “S2” indicates a state in which reception of complementary information is not completed after the terminal list is transmitted.

The terminal apparatus A transmits an acquisition request to acquire complementary information of contents to the terminal apparatus indicated in the received terminal list (S107).

The example illustrated in FIG. 39 illustrates that when an acquisition request is transmitted to the terminal apparatus B, communication with the terminal apparatus B fails.

In the example illustrated in FIG. 39, the terminal apparatus A further transmits an acquisition request to acquire complementary information of contents to the terminal apparatus C, which is another terminal apparatus indicated in the received terminal list (S107′).

The terminal apparatus C acquires divided contents data corresponding to the contents ID and divided contents ID indicated in the received acquisition request from the contents DB PG115.

The terminal apparatus C transmits the acquired divided contents data as complementary information to the terminal apparatus A that has transmitted the acquisition request (S108).

The terminal apparatus A updates divided contents data stored in the contents DB PG115 by associating the contents ID with divided contents ID indicated in the received complementary information by using the divided contents data included in the received complementary information.

The terminal apparatus A transmits connection result information indicating transmission results of an acquisition request to the terminal apparatuses B and C and a reception result of complementary information to the terminal apparatus D operating as the management node (S110).

The terminal apparatus D updates the connection result list PG220 based on the connection result information received from the terminal apparatus A.

FIG. 38 illustrates an example of the connection result list after being updated by the processing 5110 illustrated in FIG. 39.

In the example illustrated in FIG. 38, “S3” indicating that reception of complementary information is completed is set to the connection result (2203) associated with the terminal apparatus A.

In the example illustrated in FIG. 38, “S0” indicating that transmission processing of an acquisition request of complementary information failed is set to the connection result (2203) associated with the terminal apparatus B.

This illustrates an example in which the connection result list is updated based on a failure of transmission processing of an acquisition request from the terminal apparatus A to the terminal apparatus B in the processing S107 illustrated in FIG. 39.

The foregoing is the flow of processing of a whole system according to the present embodiment.

[3. Setting processing of the standby time according to the sixth embodiment] Next, setting processing of the standby time according to the present embodiment will be described.

The overall flow of owning candidate search processing in the management unit PG200 performed by a terminal apparatus according to the present embodiment is similar to the processing procedures according to the fifth embodiment illustrated in FIG. 35 and thus, a description thereof is omitted.

First, the control unit 110 detects connection result information registered correspondingly to the contents ID indicated in the search request received in the processing S600 from the connection result list PG220.

The control unit 110 counts the number of pieces of connection result information whose connection result (2203) is “S2” of the detected connection result information.

That is, the number of pieces of connection result information indicating a state in which reception of complementary information is not completed after a terminal list being transmitted is counted.

The control unit 110 sets the standby time based on the number of pieces of counted “S2” connection result information.

For example, the control unit 110 may set the standby time longer with an increasing number of pieces of “S2” connection result information and shorter with a decreasing number of pieces of “S2” connection result information.

The control unit 110 may also set an arbitrary standby time based on a random number if the number of counted “S2” connection result information is equal to or more than a certain threshold and set the standby time to 0 if the number of counted “S2” connection result information is less than the certain threshold.

That is, when the number of pieces of “S2” connection result information is less than the certain threshold, transmission processing of a terminal list is performed without performing standby processing.

It is highly probable that terminal apparatuses in a state in which reception of complementary information is not completed after a terminal list being transmitted are performing reception processing of complementary information from another terminal apparatus.

That is, with an increasing number of terminal apparatuses in a state in which reception of complementary information is not completed after a terminal list being transmitted, the number of terminal apparatuses performing reception processing of complementary information increases.

Thus, by setting the standby time in accordance with the number of terminal apparatuses in a state in which reception of complementary information is not completed after a terminal list being transmitted, an overload of a network by transmission and/or reception processing of complementary information being concentrated may be avoided.

### Other Embodiments

All or a portion of processing described as being automatically performed among processes described in the above embodiments may manually be performed.

Or, all or a portion of processing described as being manually performed may automatically be performed by a known method.

Further, all or a portion of processing performed by each apparatus indicated in the present embodiment may be realized by hardware based on wired logic.

What is claimed is:

1. A terminal apparatus connectable as a node apparatus to an information sharing system having a plurality of node apparatuses mutually communicable via a network, the terminal apparatus comprising:
a reservation input unit that accepts an operation to reserve reception of contents;
a reservation transmission unit that transmits reservation information including a contents ID for identifying the contents whose reservation operation is accepted and terminal information for identifying the terminal apparatus that accepts the reservation operation to the terminal apparatus determined based on the contents ID;
a reservation receiving unit that receives the reservation information transmitted from the terminal apparatus that accepts the reservation operation of delivery of the contents and updates a reservation terminal list that associates the contents ID for identifying the contents with the terminal information for identifying the terminal apparatus reserved for delivery of the contents based on the received reservation information;
a verification processing unit that, if the contents whose reservation operation is accepted by the reservation input unit are acquired, verifies whether the acquired contents have defects, and an owning candidate search unit that transmits a search request having the contents ID to identify the contents judged to have defects by the verification processing unit to the terminal apparatus determined based on the contents ID to acquire a search result from the terminal apparatus to which the search request is transmitted;
a search processing unit that receives the search request transmitted from the terminal apparatus judged to have defects in the delivered contents, acquires the terminal information registered in association with the contents ID included in the search request from the reservation terminal list, and transmits the acquired terminal information as a search result; and
a complementary processing unit that acquires recovery data of the contents judged to have defects by the verification processing unit from the terminal apparatus identified by the terminal information indicated in the search result acquired by the owning candidate search unit to perform recovery of the contents using the acquired recovery data.

2. The terminal apparatus according to claim 1, further comprising:
a standby processing unit that sets a standby time during which transmission processing of the search request to the terminal apparatus determined based on the contents ID is put on standby,
wherein the owning candidate search unit performs transmission of the search request to the terminal apparatus determined based on the contents ID after the standby time set by the standby processing unit passes.

3. The terminal apparatus according to claim 1, further comprising:
a reservation transfer unit that acquires the terminal information registered in association with the contents ID indicated in reservation information received by the reservation receiving unit from the reservation terminal list and transmits the received reservation information to the terminal apparatus identified by the acquired terminal information,
wherein the owning candidate search unit selects a local terminal apparatus that accepts the reservation operation as the terminal apparatus determined based on the contents ID and transmits a search request to the search processing unit held by the local terminal apparatus.

4. The terminal apparatus according to claim 3, further comprising:
a second standby processing unit that sets a standby time during which processing to acquire recovery data of contents judged to have defects by the verification processing unit from the terminal apparatus identified by the terminal information indicated in the search result acquired by the owning candidate search unit is put on standby,
wherein the complementary processing unit performs processing to acquire the recovery data of the contents after the standby time set by the standby processing unit passes.

5. A computer program product stored in a tangible computer readable medium for a terminal apparatus that may be connected, as a node apparatus, to an information sharing system having a plurality of node apparatuses mutually communicable via a network, the computer program product including computer executable instructions that causes a computer operating as the terminal apparatus to execute:
accepting an operation to reserve reception of contents;
transmitting reservation information including a contents ID to identify the contents whose reservation operation is accepted and terminal information to identify the terminal apparatus that accepts the reservation operation to the terminal apparatus determined based on the contents ID;
receiving the reservation information transmitted from the terminal apparatus that accepts the reservation operation and updating a reservation terminal list that associates the contents ID to identify the contents with the terminal information to identify the terminal apparatus reserved for delivery of the contents based on the received reservation information;
verifying whether or not the acquired contents have defects if the contents whose reservation operation is accepted are acquired;
acquiring a search result from the terminal apparatus to which the search request is transmitted by transmitting a search request having the contents ID to identify the contents judged to have defects by the verification to the terminal apparatus determined based on the contents ID;
receiving the search request transmitted from the terminal apparatus judged to have defects in the delivered contents, acquiring the terminal information registered in association with the contents ID included in the search request from the reservation terminal list, and transmitting the acquired terminal information as a search result; and
acquiring recovery data of the contents judged to have defects by the verification from the terminal apparatus identified by the terminal information indicated in the acquired search result and performing recovery of the contents using the acquired recovery data.

6. A terminal apparatus connectable, as a node apparatus, to an information sharing system having a plurality of node apparatuses mutually communicable via a network, comprising:
a reservation receiving unit that receives reservation information transmitted from the terminal apparatus that accepts a reservation operation of delivery of contents and updates a reservation terminal list that associates a contents ID to identify the contents with terminal information to identify the terminal apparatus reserved for delivery of the contents based on the received reservation information; and
a search processing unit that receives a search request transmitted from the terminal apparatus judged to have defects in the delivered contents and having the contents ID to identify the contents judged to have a result, acquires the terminal information registered in association with the contents ID included in the search request from the reservation terminal list, and transmits the acquired terminal information as a search result.

7. A terminal apparatus connectable, as a node apparatus, to an information sharing system having a plurality of node apparatuses mutually communicable via a network, the terminal apparatus comprising:
a reservation input unit that accepts an operation to reserve reception of contents;
a reservation transmission unit that transmits reservation information including a contents ID to identify the contents whose reservation operation is accepted and terminal information to identify the terminal apparatus that accepts the reservation operation to the terminal apparatus determined based on the contents ID to cause the determined terminal apparatus to update a reservation terminal list associating the contents ID to identify the contents with the terminal information to identify the terminal apparatus reserved for delivery of the contents;
a verification processing unit that, if the contents whose reservation operation is accepted by the reservation input unit are acquired, verifies whether or not the acquired contents have defects;
an owning candidate search unit that transmits a search request having the contents ID to identify the contents judged to have defects by the verification processing unit to the terminal apparatus determined based on the contents ID to acquire the terminal information registered in association with the contents ID in the reservation terminal list held by the terminal apparatus to which the search request is transmitted as a search result; and
a complementary processing unit that acquires recovery data of the contents judged to have defects by the verification processing unit from the terminal apparatus identified by the terminal information indicated in the search result acquired by the owning candidate search unit to perform recovery of the contents using the acquired recovery data.

8. The terminal apparatus according to claim 1, wherein the search processing unit sets a standby time during which transmission processing of the search result is put on standby so that transmission processing of the search result is put on standby until the set standby time passes.

9. The terminal apparatus according to claim 8, further comprising:
a first execution result storage unit that stores, in association with the contents ID included in the search request, first execution result information indicating that transmission processing of the search result is performed by the search processing unit;
a second execution result transmission unit that transmits second execution result information that is information to indicate that the complementary processing unit is executed based on acquisition of recovery data by the complementary processing unit, to the terminal apparatus determined based on the contents ID; and
a second execution result storage unit that receives the second execution result information in association with the contents ID and stores the received second execution result information in units of the contents ID,
wherein the standby time is set based on the first execution result information stored in the first execution result storage unit and the second execution result information stored in the second execution result storage unit.
